(19) United States
(12) Patent Application Publication
(10) Pub. No.: US 2017/0324119 A1
(43) Pub. Date: Nov. 9, 2017

(54) REFERENCE ELECTRODE IMPLEMENTATION WITH REDUCED MEASUREMENT ARTIFACTS

(71) Applicant: GM Global Technology Operations LLC, Detroit, MI (US)

(72) Inventors: Bob R. Powell, JR., Birmingham, MI (US); Mark W. Verbrugge, Troy, MI (US); Daniel R. Baker, Romeo, MI (US)

(73) Assignee: GM Global Technology Operations LLC, Detroit, MI (US)

(21) Appl. No.: 15/497,982

(22) Filed: Apr. 26, 2017

Related U.S. Application Data
(60) Provisional application No. 62/332,693, filed on May 6, 2016.

(51) Int. Cl. H01M 10/48; H01M 8/04537; C25B 9/08; C25B 3/00; B05D 7/20; H01M 10/0525; B05D 1/18

(52) U.S. Cl. CPC H01M 10/48; H01M 10/0525; H01M 8/04641; B05D 1/18; C25B 3/00; B05D 7/20; C25B 9/08

(57) ABSTRACT

Artifacts from the presence of a reference electrode in a thin-film cell configuration can be minimized or eliminated by providing the surface of a reference electrode with a specified surface resistivity. Theoretical considerations are set forth that show that for a given wire size, there is a theoretical surface resistance (or resistivity) that negates all artifacts from the presence of the reference wire. The theory and the experimental results hold for a electrochemical cell in a thin-film configuration.

### CROSS-REFERENCE TO RELATED APPLICATIONS

This application claims the benefit of U.S. Provisional Application No. 62/332,693, filed on May 6, 2016. The entire disclosure of the above application is incorporated herein by reference.

### INTRODUCTION

The use of reference electrodes in thin-film battery cells is a common practice. The analysis of unwanted artifacts, particularly with regard to placement of the reference electrode in batteries and in cells with opposing parallel electrodes has a long history.

The intent of using a reference electrode is to isolate the response of the electrode to be examined (termed the working electrode) from the opposing electrode in the battery (the counter-electrode). Unfortunately, the potential of the working electrode with respect to the reference electrode can, and more often than not does, depend on its geometry and size as well as its placement in the cell.

The difficulty of interpreting such data is based in part on the implicit assumption of a uniform current distribution. When this assumption holds, the potential difference between the working electrode and any fixed reference point in the separator is independent of the properties of the counter electrode, as desired.

Unfortunately, thin-film cells never attain a truly uniform current distribution for a variety of different reasons. As a result, potential differences between the working and reference electrodes exhibit “artifacts” associated with the impedance of the counter electrode. The impedance of the working electrode with respect to the reference, as well as the artifacts, are generally frequency dependent, which complicates the interpretation of results.

The art indicates the difficulty of avoiding artifacts due to non-uniformity in the current distribution, which reduces the problem of designing reference electrodes to one of minimizing such artifacts and understanding them so as not to confuse their causes with characteristics of the working electrode. There seems to be a need for modeling tools, which can be used to assess and interpret artifacts in a variety of different situations.

### SUMMARY

This section provides a general summary of the disclosure, and is not a comprehensive disclosure of its full scope or all of its features.

Artifacts from the presence of a reference electrode in a thin-film cell configuration can be minimized or eliminated by providing the surface of a reference electrode with a specified surface resistivity. Theoretical considerations are set forth that show that for a given wire size, there is a theoretical surface resistance (or resistivity) that negates all artifacts from the presence of the reference wire. The theory and the experimental results hold for a electrochemical cell in a thin-film configuration, further defined. Knowing that the surface resistance/resistivity of the reference electrode material plays a role in the presence of artifacts, a reference electrode can be empirically designed by applying a layer or layers of resistive materials on the surface of the electrode, and testing for artifacts. Alternatively, the theoretical surface resistance/resistivity of the reference electrode can be calculated according to the theoretical methods described herein and the resulting thin-film electrochemical cell tested for artifacts to confirm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a non-uniform current distribution in a thin-film battery cell;

FIGS. 2(a)-2(c). FIG. 2(a) is a schematic diagram of a cell geometry used by Adler (S. B. Adler, J. Electrochem. Soc., 149 (5) E166-E172 (2002)). FIG. 2(b) Nyquist plots of the impedance of the working electrode with respect to the reference electrode using different values of Y, based on equation (6). Values for the parameters taken from [9] in these simulations are given in Table 1. (c) Nyquist plots of the impedance of the counter electrode with respect to the reference electrode using different values of Y, based on equation (6). The inductive artifacts seen in these plots are very similar to the ones shown in FIG. 6(a) of [9]. When Y=1, there are no artifacts.

FIG. 3 is a schematic diagram of a wire reference electrode inserted between two separator layers. It is assumed that the electrodes and separator extend infinitely in both directions surrounding the reference wire. The potential 2\tilde{V}ₛₑₚ is the potential across the separator at large distance from the reference wire, where the current distribution is uniform. (See equation (17).) The potential differences Δ\tilde{V}_{W} and Δ\tilde{V}_{C} have values that vary as a function of x, depending on how close the point x is to the reference wire. (See equation (16).)

FIG. 4 is a schematic diagram of current lines (dark) and constant potential lines (lighter) based on numerical simulations of the potential equations for different parameter values.

FIGS. 5(a)-5(b) are schematic diagrams of dimensionless reference-wire potential Ψ̅₀ when Z_{W}=1 and Z_{C}=0: FIG. 5(a) K=0 , for different values of γ. Comparisons are made between numerical solutions and formulas given in Table 2. The formula in orange appears to be more accurate; FIG. 5(b) γ=½ for different values of K. Comparison of the first asymptotic formula in Table 2 and the equivalent-circuit formula with numerical solutions. Note that −Ψ̅₀ is the dimensionless form of the impedance artifacts. Numerical calculations determined that ψ̅_{2,0}(0,0)=−0.33 and (∂ψ̅_{2,0}/∂y̅)|_{r̅=0}=0.41.

FIG. 6 is a schematic diagram of a Nyquist plot comparing numerical solutions and the equivalent-circuit formula shown in Table 2 for a cell with internally placed reference wire with parameters shown in Table 1. The dimensionless wire diameter is γ=½, and the dimensionless surface resistance K=0,100. When K=0, the artifacts are inductive in nature, but when K=100, the artifacts become capacitive.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “attached to” or “coupled to” another element or layer, it may be directly on, engaged, connected, attached or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

In one embodiment, a thin-film electrochemical cell contains a working electrode, a counter electrode, a separator disposed between the two electrodes and holding the two electrodes in a spaced-apart relation, an electrolyte in the separator and in fluid contact with the working electrode and the counter electrode, and a reference electrode disposed in the separator between the counter and working electrodes. The reference electrode is a conductive material having a resistive coating applied to its surface. In various embodiments, the resistive coating is an ion resistive coating.

The resistive coating is chosen among organic polymers, ceramics, and other materials that raise the surface resistance/resistivity of the reference electrode. Non-limiting examples include nitrides, carbides, and oxides of aluminum, calcium, magnesium, titanium, silicon, and zirconium. In various aspects, the surface resistance/resistivity of the reference electrode is higher than the surface resistance/resistivity of the conducting metal(s) comprising the reference electrode. That is, in certain embodiments, the reference electrode is a wire made of a conductive material upon which a resistive layer is applied. As detailed further herein, in certain embodiments, the electrolyte is characterized with a conductivity σ, the electrodes are spaced apart by a distance L, the radius of the reference electrode is R₀, and the surface resistance/resistivity of the reference electrode in ohm-cm² is numerically equal to the radius R₀ in cm divided by the conductivity σ of the electrolyte in (ohm-cm)⁻1 so as to minimize unwanted measurement artifacts.

In another embodiment, a method of constructing an electrode chemical cell is provided. The cell contains a working electrode and a counter electrode separated by a separator that contains an electrolyte. The cell further contains a reference electrode in the form of a wire and disposed between the working and counter electrodes. The cell is essentially free of impedance artifacts attributable to the presence of the reference electrode. The method involves applying a resistive coating to a first thickness onto the surface of the reference electrode, installing the electrode in the cell, and optionally testing whether there are any artifacts. The method further involves applying a resistive coating to the coated reference electrode to a second thickness that is greater than the first thickness. Thereafter, the cell can again be tested for artifacts. In various aspects, the resistive coating is applied by a process consisting of: atomic layer deposition, chemical vapor deposition, physical vapor deposition, radio frequency sputtering, and combinations thereof. In certain variations, the resistive coating may be applied by dipping the wire into a molten organic polymer.

In another embodiment, a thin-film electrochemical cell is provided that exhibits essentially no impedance artifacts that are attributable to the presence of a reference electrode. The cell contains a working electrode, a counter electrode, and a separator disposed between the two electrodes and holding the electrodes in a spaced-apart relation. There is an electrolyte in the separator and the electrolyte is in fluid contact with the working electrode and the counter electrode. A reference electrode is disposed in the separator between the counter and working electrodes. In certain aspects, the electrolyte has a conductivity σ and the electrodes are spaced apart by a distance L. The reference electrode is a wire having a radius of R₀, and the surface resistance/resistivity of the reference electrode in ohm-cm² is numerically equal to the radius R₀ in cm divided by the conductivity σ in (ohm-cm)⁻¹.

In various embodiments, batteries are provided that contain a plurality of the thin-film electrochemical cells. The batteries can be rechargeable batteries and can include lithium ion batteries, in non-limiting fashion. Other applications for the electrochemical cells include cells for electroorganic synthesis, fuel cells, and the like.

These embodiments and others are based on the discovery that, in a thin-film electrochemical cell containing a reference electrode, and in particular containing a reference electrode disposed directly between the working and the counter electrodes, impedance artifacts can be reduced or eliminated by providing the surface of the reference electrode material with a resistive coating. That is, it has been determined that in the thin-film configuration containing a reference electrode, there is a theoretical surface resistance for a given wire size that negates all of the artifacts from the reference wire. Essentially, increasing surface resistance beyond the point where artifacts are negated turns the inductive artifacts due to wire size into capacitive artifacts due to surface resistance.

Reference electrodes are used in testing and designing thin-film cells in order to distinguish the effects of the positive and negative electrodes and determine the sources of significant resistance (or, more generally, impedance), but the reference electrode introduces some distortion into the measurement due to non-uniformity of the current distribution. This non-uniformity often arises due to edge effects or to the size and placement of the reference electrode or both. Two common geometries for placing reference electrodes are internally, between the cathode and anode, and externally at a distance from the cathode and anode. Each design introduces some level of distortion, which must be clarified. This work focuses on internally-placed wire reference electrodes and elucidates the artifacts in half-cell impedance measurements as a way of understanding the distortion due to the reference. Published simulations of impedance artifacts rely on computationally-intensive computer simulations, but a simple formula is developed here, which can be implemented in a spreadsheet, to accurately approximate these effects. The formula is derived using a singular perturbation approximation to the impedance and then combining it with a simple equivalent circuit. Some comparisons with detailed numerical simulations show the accuracy of the resulting formula as a function of the diameter of the reference wire and its surface resistance.

### Architecture

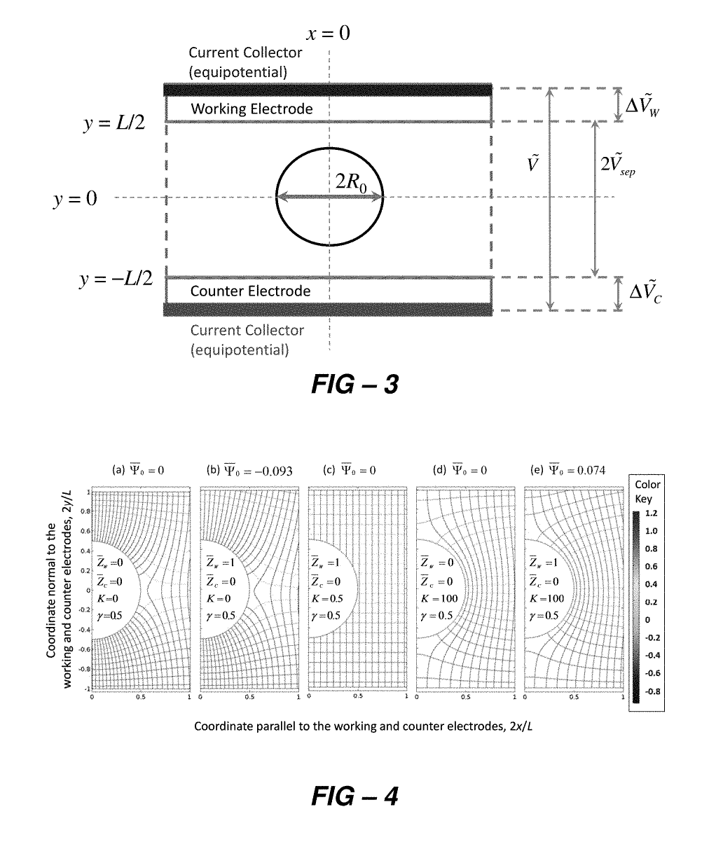

A diagram of an electrochemical cell in a thin-film configuration is shown, for example, in FIG. 3. The center of the reference electrode is placed at the origin x=0 and y=0. The working electrode and the counter electrode are at L/2 and −L/2, respectively, indicating that the electrodes are spaced apart by a distance L. As shown, the reference electrode is a wire having a radius of R₀. For a thin-film cell, like a lithium ion cell, representative dimensions are L=20 microns and R₀ is about 5 microns.

In FIG. 3, the maximum x dimension is much greater than the spaced apart dimension L, meaning that the cell has a thin-film configuration. In general, a cell is considered to be in a thin film configuration if the distance between the electrodes L is one tenth or less times the maximum electrode dimension, for example L<0.1 Xₘₐₓ or L<0.01 Xₘₐₓ.

FIG. 4 shows the results of various calculations of impedance artifacts due to the presence of the reference electrode in the configuration of FIG. 3. From left to right, impedance artifacts are shown for electrodes of too little surface resistance, an electrode of just the right surface resistance, and electrode of too high a surface resistance. The plot on the left shows the case where there is no interfacial resistance on the surface of the reference electrode. The resulting current flows directly through the reference electrode wire. On the other hand, on the far right there is high interfacial resistance. The current lines show that the current flows around the reference electrode. The middle picture in FIG. 4 shows the absence of impedance artifacts when K=γ, as will be explained further herein.

Minimizing Current and Potential Distortion

The variables K and γ in FIG. 4 determine the degree of current and potential dcistortion induced by the presence of the reference electrode between the electrodes of the thin-film electrochemical cell. As developed further herein, K is the dimensionless interfacial surface resistance on the reference electrode wire. K is calculated from:

2×(surface resistance on the wire)×(conductivity in separator)/(separator thickness).

In the equation, ρₛ is the surface resistance on the reference electrode, in ohm-cm². The conductivity in the separator is given by σ expressed in 1/ohm-cm. The separator thickness is L given in cm, and R is the separator resistance in ohm-cm².

For the wire size illustrated in FIG. 3, minimal distortion occurs when K=0.5. That is, K should equal γ, which in turn is given by 2R₀/L. Here again, R₀ is the wire radius, which is one-fourth the separator thickness L in the case illustrated in FIG. 3.

The value of K determines the degree of current and potential distortion induced by the presence of a reference electrode between the separators. To recap, for low artifacts, K is 2×(surface resistance on the wire)×(conductivity in separator)/(separator thickness). In principle, any of the values making up K can be varied or optimized in order to obtain a K value equal to γ, which leads to minimal distortion. In practice, one variable to control is the surface resistance on the wire. Therefore, in various embodiments, the current teachings provide for adding a resistive coating onto the reference electrode (and thereby changing its surface resistance/resistivity) before it is installed as a reference electrode in a thin-film electrochemical cell.

The surface resistance of the resistive layer on the reference electrode in turn is affected by its bulk resistivity (or its inverse, the conductivity) and the thickness of the coating. In general, the surface resistance/resistivity of the coated reference electrode increases as the thickness of the resistive layer increases. The absolute value of the surface resistance/resistivity is also dependent on the particular material used. A selection of material and thickness is made to provide a reference electrode having the desired surface resistance/resistivity. In addition to its effect on the surface resistance/resistivity, a resistive layer material is also selected depending on the use temperature, its stability in the electrolyte, achievable porosity, and other factors.

### Resistive Layer Materials

Resistive layer materials include, in various embodiments, organic polymers, inorganic materials such as ceramics, diamond-like carbon, conversion dip coatings, and the like. Resistive layers are applied by a variety of techniques, including atomic layer deposition, chemical vapor deposition, physical vapor deposition, dip coating a molten polymer, layer by layer assembly, radio frequency (Rf), sputtering, plasma spray, and the like. Suitable organic coatings include polyaniline, fluoropolymers such as polytetrafluoroethylene, polyethylene oxide, and sulfonated fluoropolymers such as Nafion® materials.

As noted, polymers can be applied to the reference electrode by dipping the electrode in a molten bath of the polymer. The thickness of the polymer can be increased by dipping multiple times to apply multiple layers.

Atomic layer deposition is described, for example, in U.S. Pat. No. 8,470,468 issued Jun. 25, 2013, the disclosure of which is incorporated by reference. The method involves reacting a metal compound vapor with hydroxyl groups on the surface of the reference electrode to form a conformal layer. This step is followed by reacting a non-metal compound vapor containing one of oxygen, carbon, nitrogen, and sulfur with the metal compound on the surface of the electrode to form a conformal layer made up of a solid ceramic metal compound containing at least one of oxygen, carbon, nitrogen, and sulfur. Advantageously, the conformal ceramic metal compound layer is substantially coextensive with the surface of the reference electrode. If desired, the steps are repeated successively until a ceramic metal compound layer of desired thickness has been formed. In various embodiments, the method provides for addition of carbides, nitrides, oxides, or sulfides of metals such as aluminum, calcium, magnesium, silicon, titanium, and zirconium onto the surface of the reference electrode. Non-limiting examples include aluminas, aluminas plus oxyfluorides, and titanates. By all of these methods, resistive layers of suitable thickness can be applied to the conductive material of the reference electrode used in a thin-film electrochemical cell. In this way, various materials are used that provide the resistive layer. Using the reference electrode thus coated in a thin-film electrochemical cell results in reduction or elimination of measured impedance artifacts during operation of the cell.

The surface resistivity of the coated reference electrode varies according to the nature of the coating and its thickness. In various embodiments, the surface resistivity is 1×10⁻¹⁰ ohm-cm² or higher, 1×10⁻⁹ ohm-cm² or higher, 1×10⁻⁸ ohm-cm² or higher, or 1×10⁻⁷ ohm-cm² or higher.

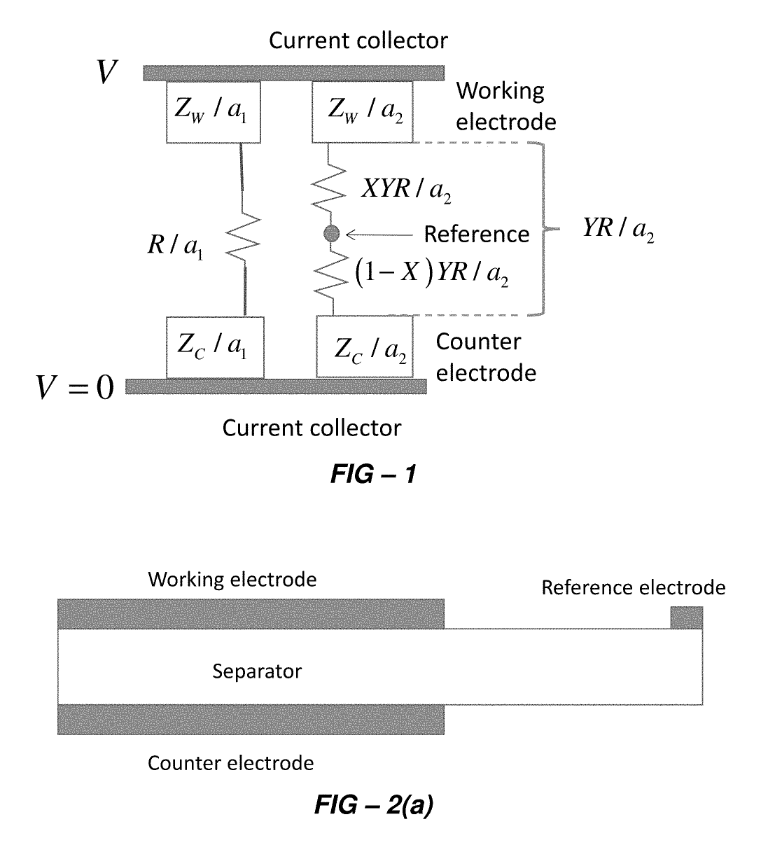

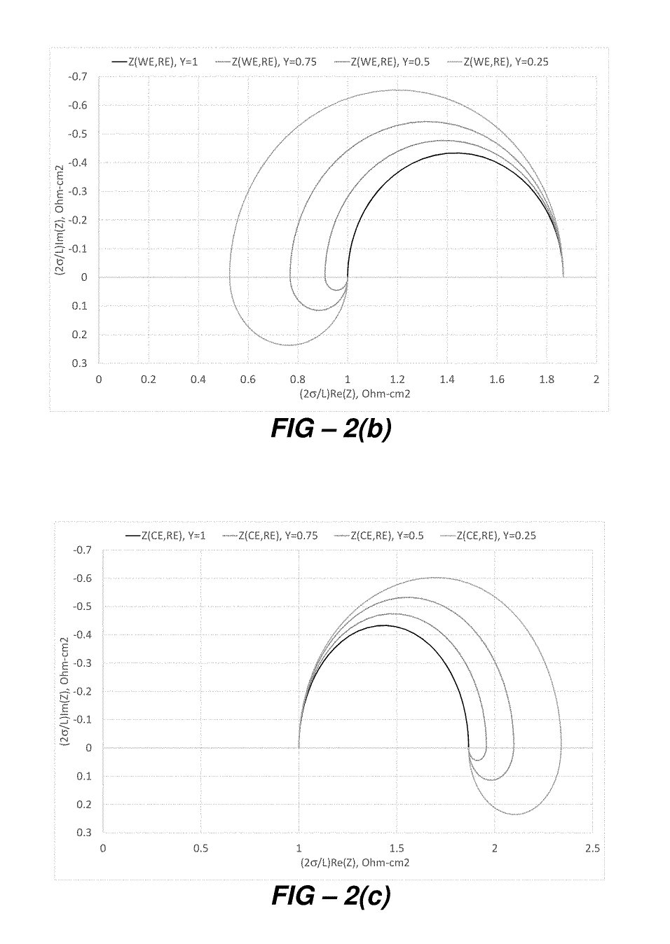

In the next section, a simple equivalent circuit (FIG. 1) can be used to derive formulas for the impedance of the working electrode with respect to the reference. The formulas depend on the impedance of the counter-electrode as well, which yields explicit formulas for the artifacts due to non-uniform current and how they depend on the impedances of both electrodes. These formulas give useful qualitative information in a variety of different settings. In particular, the equivalent circuit can simulate impedance artifacts that arise both when the reference is external to the working and counter electrodes (see, for example, FIG. 2(a)) and when it is placed internally in the form of a wire between the working and counter electrodes (FIG. 3). Although the equivalent circuit provides a quick way to assess the nature of artifacts, it also has its shortcomings. For the case of an internally placed reference wire, the size and nature of the artifacts depend both on the ratio γ of wire diameter to separator thickness and the ratio of any interfacial resistance at the wire surface to the separator resistance without the wire. Unfortunately, there is no apparent easy way to incorporate these details into the equivalent circuit. In the present disclosure more detailed models are used, based on partial differential equations, to derive a simple formula to approximate how one parameter in the equivalent circuit (the one controlling non-uniformity of the current distribution) depends on both wire diameter and interfacial resistance of the internally placed reference wire. The accuracy of this approximation will be illustrated via comparison with numerical simulations based on the more complicated models.

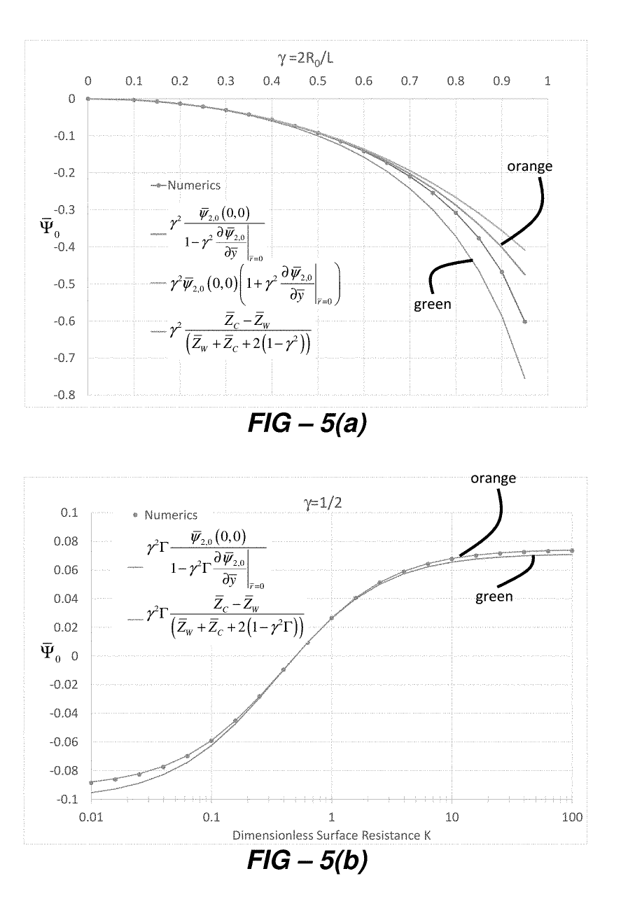

Preliminary to deriving the above approximation, it will be necessary to analyze in detail impedance artifacts due to the reference wire as described in FIG. 3. First, a study is made of how the working electrode impedance Z^{ref} with respect to the reference depends on the diameter of the reference wire, assuming no interfacial resistance on the wire. As the ratio γ of wire diameter to separator thickness tends to zero, the current distribution about the wire becomes uniform and the impedance artifacts vanish. As γ increases, the local non-uniformities in current density about the wire also increase, and so do the impedance artifacts. A singular perturbation analysis of the impedance Z^{ref} in the limit of small γ-values makes explicit this dependence, and comparison with numerical simulations shows good agreement with the perturbation formula for wire diameters as large, or larger, than half the total separator thickness. (See FIG. 5(a).) In this analysis, the electrodes are assumed to extend infinitely in all directions, a good approximation if the wire diameter and separator thickness are both much smaller than the characteristic dimension of the plan view of the electrodes; e.g., if the working and counter electrodes are circular disks, as commonly used in research cells, and the wire diameter and the separator thickness are much smaller than the radii of the electrode disks.

The perturbation analysis is then extended to include interfacial resistance on the wire surface, and a comparison of the perturbation formula with numerical simulations is again given (see FIG. 5(b)) to assess the accuracy of the approximation. It will be seen that increasing interfacial resistance and increasing wire diameter have opposing effects on the impedance artifacts, so that, for any given wire size, there is always a theoretical value for interfacial resistance that will make all impedance artifacts vanish. For the examples considered, increasing the interfacial resistance beyond this value changes inductive impedance artifacts into capacitive ones.

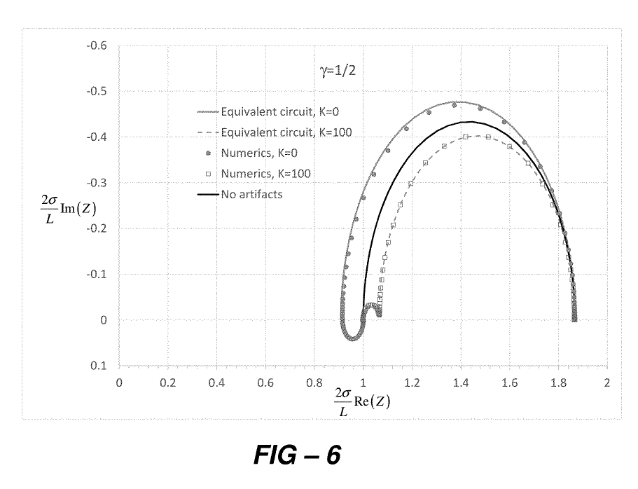

The perturbation analysis provides an explicit formula, equation (33) below, for the dependence of Z^{ref} on wire diameter and interfacial surface resistance, but this formula still depends on a function ψ̅_{2,0} that must be determined numerically. However, the formula (33) can be related to the formula for impedance derived from the equivalent circuit. By re-arranging terms in the equivalent-circuit formula, a direct comparison between terms in equation (33) and terms from the equivalent-circuit formula becomes possible. The result suggests how to relate the parameter in the equivalent circuit, which controls non-uniformity of the current distribution, to the dimensionless forms of the wire diameter and the interfacial resistance. Some comparisons are then made in specific cases between numerical simulations of impedance artifacts, the perturbation approximation, and the approximation using the equivalent circuit. The results are given in FIGS. 5 and 6.

Preliminary Background from the Analysis of an Equivalent Circuit

FIG. 1 represents the simplest circuit diagram of a non-uniform current distribution in a thin-film battery cell. Z_{W} represents the area-based impedance of the working electrode (in Ohm-cm²) and Z_{C} represents the area-based impedance of the counter electrode. The current collector of the working electrode has the potential V and the current collector of the counter electrode is assumed to be grounded. The area of each electrode has been divided into two regions of areas a₁ and a₂. It is assumed that current only flows within each region, not between the regions. This greatly simplifies the impedance calculations that follow, and some discussion of the limitations imposed by this assumption are given later in this section. The area-based separator resistance in region 1 is given as R; the area-based separator resistance in region 2 is given as YR, but the reference electrode has been placed at a fractional distance X from the working electrode, 0<X <1. When Y≠1, these different separator resistances give rise to different current densities in each region.

Some physical examples that can be represented by the schematic diagram in FIG. 1 are considered herein. FIG. 2(a) shows a typical position for a reference electrode external to the working and counter electrodes. In order to use the circuit diagram to simulate this situation, Region 1 is the interior of the electrode, where the current density is uniform, and Region 2 is a small region at the edge of the electrode, where the current density is higher than in the interior. The larger current density in Region 2 arises because of a smaller effective separator resistance at the edge, as opposed to in the interior. It follows that the parameter Y<1, although a more precise estimate of the value of Y requires more detailed numerical calculations. The exterior reference is positioned in Region 2.

A second example occurs when a reference wire is positioned between the working and counter electrodes as shown in FIG. 3. Such a reference wire disturbs the current paths in neighborhood surrounding it, which leads to a different current density in the vicinity of the wire, and locations near the wire can be thought of as Region 2 in the circuit diagram, whereas the rest of the cell, which has a uniform current distribution, should be thought of as Region 1.

The impedance with respect to the reference electrode is calculated as follows. First the current in each region as calculated as

$${I}_{1} = \frac{{Va}_{1}}{{Z}_{W} + {Z}_{C} + R} \\ {I}_{2} = \frac{{Va}_{2}}{{Z}_{W} + {Z}_{C} + YR} \qquad ( 1 )$$

The voltage between the working current collector and the reference is given as

$${V}^{ref} = \frac{{I}_{2}}{{a}_{2}} ( {Z}_{W} = XYR ) \qquad ( 2 )$$

The impedance of the working electrode with respect to the reference electrode is given as

$$\begin{matrix}{Z}^{ref} = ( {a}_{1} + {a}_{2} ) \frac{{V}^{ref}}{{I}_{1} + {I}_{2}} = \frac{( {a}_{1} + {a}_{2} )}{{a}_{2}} ( {Z}_{W} + XYR ) \frac{{I}_{2}}{{I}_{1} + {I}_{2}} \\ = ( {Z}_{W} + XYR ) [ \frac{( {a}_{1} + {a}_{2} ) ( {Z}_{W} + {Z}_{C} + R )}{{a}_{1} ( {Z}_{W} + {Z}_{C} + YR ) + {a}_{2} ( {Z}_{W} + {Z}_{C} + R )} ]\end{matrix} \qquad ( 3 )$$

Note that, when Y=1, the current densities in each region are equal and equation (3) becomes

Z^{ref}=Z_{W}+XR (4)

Equation (3) is rewritten as

$${Z}^{ref} = {Z}_{W} + XR - ( 1 - Y ) R [ \frac{{a}_{1} [ {XZ}_{C} - ( 1 - X ) {Z}_{W} ] + {a}_{2} X [ {Z}_{W} + {Z}_{C} + R ]}{{a}_{1} ( {Z}_{W} + {Z}_{C} + YR ) + {a}_{2} ( {Z}_{W} + {Z}_{C} + R )} ] \qquad ( 5 )$$

When Y=1, the term with brackets in equation (5) vanishes, but for Y≠1, this term is a measure of the artifacts introduced into Z^{ref} due to current non-uniformity. When Y=1, the impedance Z^{ref} is independent of the impedance of the counter electrode, as desired. A formula analogous to equation (5) holds for the impedance of the counter electrode with respect to the reference, but in this case X must be replaced with 1−X and Z_{W} must be interchanged with Z_{C}.

Both the internally and the externally placed reference electrodes share some common properties. First of all, the current density in the Region 2, containing the reference electrode, is not really uniform, as it is represented in the circuit diagram. This is a major limitation of the circuit diagram in FIG. 1, which could be corrected by including parallel connections, as opposed to just serial connections, within the part of the circuit that represents separator resistance. However, doing this would significantly complicate the formula for Z^{ref} in equation (5), which is why it hasn't been done. Even without these complications, equation (5) is capable of capturing many of the critical phenomena associated to impedance artifacts, as is illustrated below. A second common property of both examples is the fact that the area of Region 2, containing the reference electrode, is much smaller than the area of Region 1. In light of this fact, equation (5) can be somewhat simplified by considering the limit as a₂ tends to zero, resulting in

$${Z}^{ref} = {Z}_{W} + XR - ( 1 - Y ) R [ \frac{{XZ}_{C} - ( 1 - X ) {Z}_{W}}{{Z}_{W} + {Z}_{C} + YR} ] \qquad ( 6 )$$

One interesting conclusion to be drawn from equation (6) is in the case of a symmetric cell, where

Z_{C}=Z_{W} and X=½ (7)

The condition X=½ will hold if the reference wire is centered at the mid-point of the separator layer, or if the external reference is far enough away from the working and counter electrodes, whose edges are aligned. When equations (7) hold, equation (6) simplifies to

$${Z}^{ref} = {Z}_{W} + \frac{R}{2} \qquad ( 8 )$$

It follows that there are no artifacts associated to a reference electrode in a symmetric cell, as long as equation (7) holds. On the other hand, if the reference wire is placed asymmetrically between the working and counter electrodes internally, or it is too close to them externally, then X≠½ and the above simplification does not hold.

In [9], finite element simulations of the impedance of a cell were made, in which a reference electrode was positioned as shown in FIG. 2(a). The impedances of the working and counter electrodes were each approximated by a resistor and capacitor in parallel, having the values taken from [9] and given in Table 1. Finite element calculations of the impedances of both the working and counter electrode with respect to the reference showed inductive artifacts, as illustrated in FIG. 6a of [9]. These results can also be interpreted qualitatively in a much simpler way with the aid of equation (6). As noted above, the parameter Y<1, although a more precise estimate of the value of Y would require more detailed numerical calculations. Nyquist plots based on equation (6), using values from Table 1, are shown in FIG. 2(b) for different values of Y<1. FIG. 2(c) shows the corresponding plots for the impedance of the counter electrode with respect to the reference, again for different Y-values, based on equation (6), but with X replaced by 1−X and Z_{W} replaced by Z_{C}. The results are very similar to those depicted in FIG. 6a of [9] using finite elements. FIGS. 2(a)-2(c) demonstrate that it is often possible to get a good qualitative picture of impedance artifacts using equation (6) and thereby avoiding difficult and time-consuming finite element simulations. The parameter Y, which controls the non-uniformity of the current distribution, determines the size of the impedance artifacts.

In the case of the reference wire shown schematically in FIG. 3, equation (6) is still very useful for depicting the dependence of Z^{ref} on the impedances of the electrodes Z_{W} and Z_{C}, but it is not at all useful if one wants to study the dependence of the impedance artifacts on the wire diameter or on a surface resistance at the interface between the wire and separator. As the wire diameter tends to zero, the current distribution becomes uniform and the artifacts disappear. Clearly the wire diameter will impact the parameter Y in the circuit diagram, but more detailed calculations are needed to make this dependence explicit. In the next section, a different approach to this problem is explored, based on singular perturbation theory. This will then be used to propose a functional dependence of the parameter Y on reference wire size and surface resistance.

Impedance with Respect to a Wire Reference as a Function of Wire Size and Interfacial Resistance

The geometry of the separator and the wire is represented in FIG. 3. The origin of the coordinate system is assumed to be located at the center of the wire. Define

γ=2R₀/L (9)

The wire is centered about the middle of the separator, with radius R₀, and the electrodes and the separator are assumed to extend infinitely in the x-direction.

The formulation of charge transport equations that can be used to calculate impedance can be found in several different textbooks, [1,20]. Suppose that a time-dependent voltage V(t) is imposed between the current collectors of the working and counter electrodes of a cell, and let

$$\tilde{V} ( ω ) = \frac{1}{2 π} {\int }_{- ∞}^{∞} V ( t ) exp [ - j ω t ] dt \qquad ( 10 )$$

be the transform of V(t). The current-voltage relationship in the cell must be linear to take a Fourier transform. Nonlinear systems must first be linearized about some DC (direct current) voltage V₀. Fourier transforms are then taken of the difference between any quantity and its DC value. In a similar manner, let I(t) be the average current density between current be the Fourier collectors with Fourier transform Ĩ(ω). Then the area-based impedance (with units of resistance multiplied onto area) between the working and counter electrode is defined as

$$Z ( ω ) = \frac{\tilde{V} ( ω )}{\tilde{I} ( ω )} \qquad ( 11 )$$

The impedance of the working electrode with respect to a reference electrode is given by

$${Z}^{ref} ( ω ) = \frac{{\tilde{V}}^{ref} ( ω )}{\tilde{I} ( ω )} \qquad ( 12 )$$

where \tilde{V}^{ref}(ω) represents the Fourier transform of the voltage difference between the working and reference electrodes. Note that Ĩ(ω) has the same definition in equations (11) and (12).

If the system of transport equations that dictates current and voltage between the working and counter electrodes is linearized about some DC condition, the equations determining \tilde{V}(ω), \tilde{V}^{ref}(ω), Ĩ(ω) are simply the Fourier transforms of the corresponding transport equations in the time domain. An example of this process is given in [18]. For simplicity, in this work the conductivity σ of the separator will be treated as constant (reflecting ohmic drop only), independent of electrolyte concentration. The porous electrodes are also represented as lump sum area-based impedances, Z_{W} in the working electrode and Z_{C} in the counter electrode, which depend on frequency but are otherwise constant. Z_{W} can be understood as the impedance of the working electrode with respect to a reference electrode located at the separator interface to the working electrode, but this reference electrode would have to be infinitely small in size, so that it would not disturb the otherwise uniform current distribution that is assumed in the cell. In reality, the circular reference wire represented in FIG. 3 is finite in size, and it does result in a non-uniform current distribution. As noted in the previous section, this results in artifacts which obscure the actual value of Z_{W}, when Z^{ref} is measured with respect to the actual reference wire.

In the separator,

∇²\tilde{ψ}=0 and ĩ=σ∇\tilde{ψ} (13)

where \tilde{ψ} is the potential in the separator and ĩ is the local current density (not to be confused with Ĩ(ω), the average current density). The potential and current are split into real and imaginary parts. Thus, for \tilde{ψ}=Real(\tilde{ψ})+jImaginary(\tilde{ψ}) and ĩ=Real(ĩ)+jImaginary(ĩ), where j=\sqrt{−1}, Eq. (13) can be recast as ∇²Real(\tilde{ψ})=0 and Real(ĩ)=σ∇Real(\tilde{ψ}) ∇²Imaginary(\tilde{ψ})=0 and Imaginary(ĩ)=σ∇Imaginary(\tilde{ψ}). This same procedure is carried through the complex analysis, but the redundant structure in subsequent exposition will not be shown. (It will simplify the exposition in what follows to refer to ĩ as a current density and \tilde{ψ} as a potential, without always repeating the words “Fourier transform”, and the same convention applies to any variable with a tilde over it). If the potential difference between the current collectors (assumed to be equipotential) of the working and counter electrodes is \tilde{V} (see FIG. 3), then

$$\tilde{V} = \tilde{I} ( {Z}_{W} + {Z}_{C} + \frac{L}{σ} ) \qquad ( 14 )$$

Equation (14) holds at points far away from the reference wire, where the current distribution is uniform, and the area of this region is assumed to be much larger than the small region surrounding the reference wire, in which the current density varies. For this reason, one can identify the average current density Ĩ with the uniform current density at points far from the reference wire. The impedance of the working electrode with respect to the counter electrode is then simply given as

$$Z ( W , C ) = {Z}_{W} + {Z}_{C} + \frac{L}{σ} \qquad ( 15 )$$

The impedance of the working electrode with respect to the reference electrode can only be calculated by solving the potential equation (13) to determine the potential at the reference wire. The boundary conditions for equation (13) are formulated next. It is helpful to refer to FIG. 3 for a description of the potential differences referred to in following equations. The potential drop across the working or counter electrode, from current collector to separator interface, at any position x is given as

$$Δ {\tilde{V}}_{W} ( x ) = {Z}_{W} σ \frac{\partial \tilde{ψ}}{\partial y} {\vert}_{( x , y = L / 2 )} \\ Δ {\tilde{V}}_{C} ( x ) = {Z}_{C} σ \frac{\partial \tilde{ψ}}{\partial y} {\vert}_{( x , y = - L / 2 )} \qquad ( 16 )$$

where the gradient ∂\tilde{ψ}/∂y is taken in the separator at the interface to the electrode at y=±L/2. At large distances from the reference wire, the current distribution is uniform, the potential drop across the separator of thickness L is given by \tilde{ψ}(x,L/2)−\tilde{ψ}(x,−L/2), and the current density takes the form

$$\begin{matrix}\tilde{I} = \tilde{i} = \frac{σ}{L} [ \tilde{ψ} ( x , L / 2 ) - \tilde{ψ} ( x , - L / 2 ) ] = \frac{2 σ}{L} {\tilde{V}}_{sep} & ( 17 ) \\ where & \\ {\tilde{V}}_{sep} = [ \tilde{ψ} ( x , L / 2 ) - \tilde{ψ} ( x , - L / 2 ) ] / 2 & \end{matrix}$$

At such points, equation (14) implies that the voltage difference between current collectors is

$$\tilde{V} = \frac{2 σ}{L} {\tilde{V}}_{sep} ( {Z}_{W} + {Z}_{C} + \frac{L}{σ} ) \qquad ( 18 )$$

Since potential is only defined up to an arbitrary constant, using equation (17), one can set

\tilde{ψ}(x,±L/2)=±\tilde{V}ₛₑₚ (19)

at all points x far enough away from the reference wire. The potential at each current collector, in terms of \tilde{V}ₛₑₚ, follows from equation (16)

$${\tilde{V}}_{sep} + Δ {\tilde{V}}_{W} = {\tilde{V}}_{sep} ( 1 + 2 {Z}_{W} \frac{σ}{L} ) at the working electrode current collector - {\tilde{V}}_{sep} - Δ {\tilde{V}}_{C} = - {\tilde{V}}_{sep} ( 1 + 2 {Z}_{C} \frac{σ}{L} ) at the counter electrode current collector \qquad ( 20 )$$

At points on the separator interfaces, equations (16) and (20) imply that

$$\begin{matrix}\tilde{ψ} = {\tilde{V}}_{sep} + Δ {\tilde{V}}_{W} - {Z}_{W} σ \frac{\partial \tilde{ψ}}{\partial y} on the upper separator boundary y = L / 2 = {\tilde{V}}_{sep} ( 1 + 2 {Z}_{W} \frac{σ}{L} ) - {Z}_{W} σ \frac{\partial \tilde{ψ}}{\partial y} & ( 21 ) \\ \begin{matrix}\tilde{ψ} = - {\tilde{V}}_{sep} - Δ {\tilde{V}}_{C} + {Z}_{C} σ \frac{\partial \tilde{ψ}}{\partial y} on the lower separator boundary y = - L / 2 \\ = - {\tilde{V}}_{sep} ( 1 + 2 {Z}_{C} \frac{σ}{L} ) + {Z}_{C} σ \frac{\partial \tilde{ψ}}{\partial y}\end{matrix} & \\ \tilde{ψ} \to \frac{2 {\tilde{V}}_{sep}}{L} y as x \to \pm ∞ & \end{matrix}$$

The following scalings are introduced:

$$\begin{matrix}x = \frac{L}{2} \overline{x} , & y = \frac{L}{2} \overline{y} , & r + \sqrt{{x}^{2} + {y}^{2}} = \frac{L}{2} \overline{r} , & \tilde{ψ} = \frac{\tilde{ψ}}{{\tilde{V}}_{sep}} , & {\overline{Z}}_{i} = & \frac{2 {Z}_{i} σ}{L} , \overline{i} = \frac{L}{2 σ {\tilde{V}}_{sep}} \tilde{i}\end{matrix} \qquad ( 22 )$$

In scaled form, the above equations become

$$\begin{matrix} {∇}^{2} \overline{ψ} = 0 & ( 23 ) \\ \overline{ψ} = 1 + {\overline{Z}}_{W} ( 1 - \frac{\partial \overline{ψ}}{\partial \overline{y}} ) on the upper separator boundary \overline{y} = - 1 & \\ \overline{ψ} = - 1 - {\overline{Z}}_{C} ( 1 - \frac{\partial \overline{ψ}}{\partial \overline{y}} ) on the lower separator boundary \overline{y} = - 1 & \\ \overline{ψ} \to \overline{y} as \overline{x} \to \pm ∞ & \end{matrix}$$

Boundary conditions at the surface of the reference wire are

$$\overline{ψ} is constant on the wire surface \overline{r} = γ {\int }_{0}^{2 π} \overline{i} \cdot n d θ = {\int }_{0}^{2 π} \frac{\partial \overline{ψ}}{\partial \overline{r}} d θ = 0 on the wire surface \qquad ( 24 )$$

The integral on the wire surface is over the angle θ=sin⁻¹(y̅/r̅). Equation (24) is consistent with a reference electrode of infinitely large electrical conductivity, yielding a constant potential throughout the interior of the reference electrode, and no interfacial resistance at the surface. The integral boundary condition above stipulates that the net current entering the electrode must be equal to that leaving the electrode. The case when interfacial resistance at the surface of the reference wire is nonzero is somewhat more complicated, and it will be treated at the end of this section.

Once equations (23) and (24) have been solved for ψ̅, the impedance of the working electrode with respect to the reference electrode can be calculated as follows. From equation (17), the average current in dimensionless form is given as Ī=1. The voltage at the current collector of the working electrode is given in dimensionless form as 1+Z̅_{W}. It follows that the dimensionless impedance with respect to the reference electrode is given as

$${\overline{Z}}^{ref} = \frac{1 + {\overline{Z}}_{W} - \overline{ψ} ( \overline{r} = γ )}{\overline{I}} = 1 + {\overline{Z}}_{W} - \overline{ψ} ( \overline{r} = γ ) \qquad ( 25 )$$

Equation (15) in dimensionless form becomes

Z̅(W,C)=Z̅_{W}+Z̅_{C}+2 (26)

It follows that the impedance of the counter electrode with respect to the reference is given as

Z̅(W,C)−Z̅^{ref}=Z̅_{C}+1+ψ̅(r̅=γ) (27)

Formulas (25) and (27) make it clear that impedance with respect to the reference wire depends on the diameter of the wire. Note that when γ=0 and the wire is vanishingly small, the current distribution is uniform everywhere, and the potential ψ̅(r̅=0)=0. A process of matched asymptotics may be used to construct series solutions to ψ̅ as a function of γ in the limit γ<<1. It will be seen below that these approximate solutions compare quite well to numerical solutions for ψ̅ even when γ is as large as ½, that is, the wire diameter is one half the total thickness of the separator layers. Two formulas for ψ̅ have been derived, equations (A.16) and (A.21); both formulas have errors on the order of γ⁶, but equation (A.21) seems to have slightly better accuracy when compared to numerical solutions at specific γ-values. The more accurate formula is

$$\begin{matrix}\overline{ψ} = \overline{y} + {γ}^{2} \frac{( {\overline{ψ}}_{2 , 0} ( \overline{x} , \overline{y} ) - \frac{\overline{y}}{{\overline{r}}^{2}} )}{1 - {γ}^{2} \frac{\partial {\overline{ψ}}_{2 , 0}}{\partial \overline{y}} {\vert}_{\overline{r} = 0}} + O ( {γ}^{6} ) & ( 28 ) \\ \overline{ψ} ( \overline{r} = γ ) = {γ}^{2} \frac{{\overline{ψ}}_{2 , 0} ( 0 , 0 )}{1 - {γ}^{2} \frac{\partial {\overline{ψ}}_{2 , 0}}{\partial \overline{y}} {\vert}_{\overline{r} = 0}} + O ( {γ}^{6} ) & \end{matrix}$$

As discussed in the Appendix, the function ψ̅_{2,0}(x̅,y̅) is defined on the separator geometry when no reference wire is present, that is, in the region −∞<x̅<∞ and −1≦y̅≦1. It satisfies the following equation and boundary conditions

$$\begin{matrix}{∇}^{2} {\overline{ψ}}_{2 , 0} = 0 & ( 29 ) \\ {\overline{ψ}}_{2 , 0} = - {\overline{Z}}_{C} [ \frac{\partial {\overline{ψ}}_{2 , 0}}{\partial \overline{y}} - \frac{{\overline{x}}^{2} - 1}{{( {\overline{x}}^{2} + 1 )}^{2}} ] + \frac{1}{( {\overline{x}}^{2} + 1 )} at \overline{y} = 1 & \\ {\overline{ψ}}_{2 , 0} = {\overline{Z}}_{A} [ \frac{\partial {\overline{ψ}}_{2 , 0}}{\partial \overline{y}} + \frac{{\overline{x}}^{2} - 1}{{( {\overline{x}}^{2} + 1 )}^{2}} ] - \frac{1}{( {\overline{x}}^{2} + 1 )} at \overline{y} = - 1 & \\ {\overline{ψ}}_{2 , 0} \to 0 as \overline{x} \to \pm ∞ & \end{matrix}$$

Equations (25) and (28) then yield

$${\overline{Z}}^{ref} = \frac{1 + {\overline{Z}}_{W} - \overline{ψ} ( \overline{r} = γ )}{\overline{I}} = 1 + {\overline{Z}}_{W} - {γ}^{2} \frac{{\overline{ψ}}_{2 , 0} ( 0 , 0 )}{1 - {γ}^{2} \frac{\partial {\overline{ψ}}_{2 , 0}}{\partial \overline{y}} {\vert}_{\overline{r} = 0}} \qquad ( 30 )$$

Equation (30) may be generalized to the case when a surface resistance exists on the wire. In dimensioned form, the boundary condition on the reference wire becomes

$${ρ}_{s} i \cdot n = {{ρ}_{s} ( σ \frac{\partial \tilde{ψ}}{\partial r} )}_{r = R} = \tilde{ψ} {\vert}_{r = R} - {\tilde{Ψ}}_{0} \qquad ( 31 )$$

where ρₛ is the surface resistivity and \tilde{ψ}₀ is the constant potential in the wire. In dimensionless form, equation (31) becomes

$$K \frac{\partial \overline{ψ}}{\partial \overline{r}} {\vert}_{\overline{r} = γ} = \overline{ψ} {\vert}_{\overline{r} = γ} - {\tilde{Ψ}}_{0} \qquad ( 32 )$$

where K=(2ρₛσ)/L. Equation (32) is then combined with the integral condition in equation (24), which is used to determine the value of ψ̅₀. The generalization of equation (301 becomes

$${\overline{Z}}^{ref} = \frac{1 + {\overline{Z}}_{W} - {\tilde{Ψ}}_{0}}{\overline{I}} = 1 + {\overline{Z}}_{W} - {γ}^{2} Γ \frac{{\overline{ψ}}_{2 , 0} ( 0 , 0 )}{1 - {γ}^{2} Γ \frac{\partial {\overline{ψ}}_{2 , 0}}{\partial \overline{y}} {\vert}_{\overline{r} = 0}} , where Γ = \frac{γ - K}{γ + K} \qquad ( 33 )$$

Note that equation (30) is recovered when K=0. In addition, one sees that Γ=0 when K=γ, so that no artifacts will appear in Z̅_{ref}. Indeed, in this case the function ψ̅=y̅ satisfies all boundary conditions at both the working and counter electrodes as well as at the reference wire. The current distribution is thus uniform when K=γ. Parameter K can be a complex-valued impedance, if so desired.

Equation (33) still requires a numerical solution of a partial differential equation to determine ψ̅_{2,0}, but its advantage over equation (25) is that the dependence on γ and K has now been made explicit after only one numerical calculation, whereas equation (25) requires a different numerical calculation whenever γ or K vary.

It is noted that the same observations about symmetric cells, which were made by means of a circuit diagram, can also be made using equations (23) and (24). If Z_{C}=Z_{W}, then equations (23) and (24) are symmetric under inversion of the y̅-axis. It follows that

Ψ̅₀=0 and Z^{ref}=1+Z̅_{W} (34)

Equation (34) corresponds to equation (8) of the previous section.

### The Dependence of Y in the Circuit Diagram on γ and K

In order to compare formula (6), based on the equivalent circuit, to equation (33), one must assume that X=½, since formula (33) assumes that the reference wire is centered in the separator. Under this assumption, the dimensionless form of equation (6) for the equivalent circuit is given as

$$\begin{matrix}{\overline{Z}}^{ref} = {\overline{Z}}_{W} + 1 - ( 1 - Y ) \frac{{\overline{Z}}_{C} - {\overline{Z}}_{W}}{( {\overline{Z}}_{W} + {\overline{Z}}_{C} + 2 Y )} \\ = {\overline{Z}}_{W} + 1 - ( 1 - Y ) \frac{\frac{{\overline{Z}}_{C} - {\overline{Z}}_{W}}{( {\overline{Z}}_{W} + {\overline{Z}}_{C} + 2 )}}{1 - \frac{2}{( {\overline{Z}}_{W} + {\overline{Z}}_{C} + 2 )} ( 1 - Y )}\end{matrix} \qquad ( 35 )$$

Comparison of equation (35) with equation (33) shows that the two equations become equivalent if

$${\overline{ψ}}_{2 , 0} ( 0 , 0 ) = \frac{{\overline{Z}}_{C} - {\overline{Z}}_{W}}{( {\overline{Z}}_{W} + {\overline{Z}}_{C} + 2 )} , \frac{\partial {\overline{ψ}}_{2 , 0}}{\partial \overline{y}} {\vert}_{\overline{r} = 0} = \frac{2}{( {\overline{Z}}_{W} + {\overline{Z}}_{C} + 2 )} and ( 1 - Y ) = {γ}^{2} Γ \qquad ( 36 )$$

For this reason, the approximation below is suggested:

$${\overline{Z}}^{ref} = {\overline{Z}}_{W} + 1 - {γ}^{2} Γ \frac{{\overline{Z}}_{C} - {\overline{Z}}_{W}}{{\overline{Z}}_{W} + {\overline{Z}}_{C} + 2 ( 1 - {γ}^{2} Γ )} \qquad ( 37 )$$

Impedance calculations based on the approximations (35) and (37) will be compared with calculations based on equation (33) in the next section. A summary of the various formulas for impedance, based on asymptotic analysis and from the equivalent circuit, is given in Table 2.

### Accuracy of the Approximations Based on Asymptotics and the Equivalent Circuit

In this section, impedance calculations based on the numerical solutions of the full equation system (23) and (A.24) are compared to the asymptotic solutions (33) and equivalent-circuit approximations (35) and (37). (See also Table 2.) A thorough comparison would require variation of the complex-valued parameters Z_{W} and Z_{C} as well as the parameters γ and K, and this exceeds the scope of this work. On the other hand, it has already been noted that there are no artifacts when Z̅_{C}=Z̅_{W}, and equations (35)-(37) imply that the size of these artifacts in relation to the desired impedance Z_{W}+1 tends to zero when either Z̅_{C} or Z̅_{W} becomes large. This suggests that one consider the case Z̅_{W}=1 and Z̅_{C}=0, in particular, because the errors become real instead of complex, which makes a graphical comparison easier. In addition, the case posed by the example described in Table 1 will be examined.

Equations (23) and (A.24) were numerically solved using the program Comsol [21]. FIG. 4 shows both current lines and equipotential lines that were calculated for γ=½ and different values of Z_{W}, Z_{C}, and K. FIG. 4(a) shows the symmetric case with no surface resistance and zero impedance at the working and counter electrodes; in this case the potential of the wire ψ̅₀=0 by symmetry arguments. This would also be the case for any nonzero surface resistance as well. Note that by equation (33) the impedance artifacts are given by −Ψ̅₀ and without artifacts the impedance is equal to 1+Z̅_{W}. Part (b) shows results when Z_{W}=1,Z_{C}=0 and K=0. In this case, Ψ̅₀ takes on a negative value due to the asymmetry of the electrode conditions. Part (c) considers the same conditions as Part (b) except that now K=γ. As noted in the previous section, in this case the impact of surface resistance exactly balances out the impact of wire size (Γ=0), so that the reference-wire potential is again zero. Furthermore, in this case, the current distribution looks exactly as if the reference wire were not there. Cases (d) and (e) show what happens when the surface resistance is very large (K=100) and dominates the separator resistance. In both cases current goes around the reference wire instead of through it. In case (d), the electrode impedances are both zero, so that Ψ̅₀ is again zero, but in case (e), Z_{W}=1 and Z_{C}=0. Ψ̅₀ thus becomes nonzero, but it takes on the opposite sign from what is seen in case (b).

FIGS. 5(a)-5(b) explore the accuracy of the various approximations given in Table 2 for impedance, as compared to numerical simulations when Z̅_{W}=1 and Z̅_{C}=0. FIG. 5(a) assumes that K=0 and allows γ to vary. The two asymptotic formulas in Table 2 both have errors that are of order γ⁶Γ³, but the first formula in Table 2 (shown in orange in FIGS. 5(a)-5(b)) appears to be more accurate and is recommended for this reason. Also shown (in green) is the formula based on the equivalent circuit. FIG. 5(b) considers the case when γ=½ and K is varied. The comparison is made between numerical solutions, the first asymptotic formula in Table 2, and the equivalent-circuit formula.

FIG. 6 shows a Nyquist plot of impedance, based on the assumption that Z̅_{W} and Z̅_{C} are each given as a resistor and capacitor in parallel, with values taken from Table 1. The values γ=½ and K=0 and 100 were used. Shown are numerical simulations compared to the equivalent-circuit model from Table 2. When K=0, the artifacts are inductive, but when K=100, they become capacitive, because the parameter Γ=(γ−K)/(γ+K) changes sign.

### Discussion

Impedance artifacts arise whenever a reference electrode is used with a thin-film cell in which the current distribution is non-uniform. The two different configurations most commonly used for reference electrodes are an external placement of the reference, see FIG. 2(a), and the use of a reference wire placed internally between the two electrodes of the cell, see FIG. 3. In both cases, a useful way to assess the artifacts induced by the non-uniform current distribution is by means of the equivalent circuit diagram shown in FIG. 1. In region 1 (represented by the left branch of the equivalent circuit), the separator resistance is given as R, whereas in region 2 (the right branch, where the reference electrode resides), the separator resistance is given as YR; when Y≠1, artifacts due to a non-uniform current distribution occur. In the case of an externally placed reference electrode, the parameter Y<1, but the most appropriate value for Y requires a more detailed analysis of the geometry of the electrodes and the reference. The main focus of this work is to understand the artifacts produced by an internally placed reference wire. In particular, the artifacts depend on the ratio γ of the wire diameter to the total separator thickness and on the ratio K of the interfacial resistance on the surface of the reference wire to the total resistance across the separator. Our goal is to find an accurate way to approximate a value for Y in the circuit diagram as a function of γ and K. To this end, a singular perturbation analysis of the impedance Z^{ref} with respect to the reference wire was performed in the limit γ<<1. By comparing the form of the asymptotic solution (33) with the equivalent-circuit formula, it was found that the substitution

$$Y = 1 - {γ}^{2} Γ , Γ = \frac{γ - K}{γ + K} \qquad ( 38 )$$

does a good job of reproducing impedance artifacts as γ and K are varied. A summary of the various formulas for impedance which emerge from this analysis is given in Table 2. A sense for the accuracy of the perturbation analysis and the equivalent-circuit formula is given in FIGS. 5 and 6, where these formulas are compared with numerical simulations. It is hoped that the simple formulas given in Table 2, especially the formula based on the equivalent circuit, will provide users of reference electrodes a useful tool for assessing the artifacts which arise due to the reference electrode.

There is almost an unlimited number of different ways to construct three-electrode cells and the analysis given here is based on some simple idealizations. In particular, many geometries for reference electrodes would involve three-dimensional analysis, instead of the two dimensional analysis given here. Other factors might also impact the response of the cell; for example, compressing a reference wire between two layers of separators can introduce porosity differences in the separator which can change its conductivity near the reference wire. A first step toward understanding the impact of any such effect entails understanding how it impacts the parameter Y controlling non-uniformity of current density in the equivalent circuit in FIG. 1. For example, reducing separator conductivity near the reference wire will increase Y, and the equivalent circuit provides an understanding of how this impacts impedance artifacts. It should be noted, however, that the equivalent-circuit formula given in equation (6) and Table 2 is based on the assumption that the area a₂ in FIG. 1 is much smaller than the total active cell area. In cases using a mesh reference electrode [16], for example, this assumption does not hold, and this complicates the analysis. Moreover, impedance itself is based on small-signal excitation and a linearization of system properties; the impact of reference electrodes on large voltage or current variations, in which nonlinearities occur, is a difficult subject, which goes beyond the scope of the present work.

### Appendix: Singular Perturbation Solution for ψ̅ in the Limit of Small γ

Solutions are generated in two different coordinate systems. The “outer coordinates” are (x̅,y̅), defined by equation (22). In the outer coordinates, the wire has a diameter γ which becomes very small in the limit of small γ. The “inner coordinates” (\hat{x},ŷ) are a rescaling of the outer coordinates as follows

x=R\hat{x}, x̅=γ\hat{x}, y=Rŷ, y̅=γŷ, r̅=γ\hat{r} (A.1)

In the inner coordinates, the wire always has diameter one, regardless of the value of γ, but in the limit of small γ, the separator has infinite thickness, and the geometry on which the potential is defined in the inner coordinates can be viewed as the infinite plane with a unit circle removed from the origin. The transport equations for the inner problem are

$${\hat{∇}}^{2} \hat{ψ} = 0 \\ \hat{ψ} is constant on the wire s urface \hat{r} = 1 where \hat{r} = \sqrt{{\hat{x}}^{2} + {\hat{y}}^{2}} \\ {\int }_{0}^{2 π} \frac{\partial \hat{ψ}}{\partial \hat{r}} d θ = 0 at \hat{r} = 1 \hat{ψ} \to γ \hat{y} as \hat{r} \to ∞ \qquad ( A .2 )$$

Equation (A.2) assumes that the dimensionless interfacial surface resistance K is zero. (Compare equations (24) and (32). The more complicated case of nonzero K is treated later in the Appendix.) No boundary conditions at the working and counter electrodes are specified for the inner problem. Instead, it will be necessary to match the inner solution to the outer solution in some overlap region with large values of \hat{r} but small values of r̅. Similarly, one does not impose boundary conditions at the reference wire on the outer solution ψ̅ but instead uses the same matching condition to the inner solution on the same overlap region. The nature of this overlap region will be made precise during the matching process.

The matching process can now be described as follows. The outer solution is given as

ψ̅=y̅+ . . . (A.3)

The use of “+ . . . ” indicates higher order terms in γ, which vanish when γ=0. Thus the solution given in equation (A.3) represents a solution when γ=0 and the reference wire is shrunk to a single point. Equation (A.3) merely asserts that an infinitely small reference wire does not disturb the uniform current distribution or the corresponding potential. What happens when 0<γ<<1 is explored next. The outer solution does not satisfy the boundary conditions at the reference wire r̅=γ, \hat{r}=1. The inner solution is obtained by first writing the outer solution in the inner coordinates and then adding an additional term needed to satisfy the boundary condition at the wire. It takes the form

$$\hat{ψ} = γ ( \hat{y} - \frac{\hat{y}}{{\hat{r}}^{2}} ) = γ ( \hat{r} - \frac{1}{\hat{r}} ) sin θ = \overline{y} - {γ}^{2} \frac{\overline{y}}{{\overline{r}}^{2}} where \hat{r} sin θ = \hat{y} \qquad ( A .4 )$$

Note that \hat{ψ}=0 at \hat{r}=1, and that \hat{ψ} does satisfy the boundary conditions at the reference wire. This inner solution is then written in the outer coordinate system, where it is seen that the new term γ²y̅/r̅² needed to satisfy the boundary condition at the wire is higher order in γ than the previous outer solution was, as shown in equation (A.4). This new solution, however, does not satisfy the boundary conditions at the working and counter electrodes, y̅=±1. The situation is rectified by adding an additional term to the outer solution, of the same order in γ as the new term which just came from the inner solution. (The details of this will be described shortly.) The new term to the outer solution does not, however, satisfy the boundary condition at the reference wire, and the process must be iterated. With each iteration, higher order terms in γ are introduced, both to the inner and outer solutions, which increase the accuracy of the approximations to both.

Turning now to the details of computing these higher order terms. When equation (A.4) is written in the outer coordinates, it no longer satisfies the boundary conditions at y̅=±1. To correct this problem, a new function ψ̅_{2,0}(x̅,y̅) is discussed such that

$$\overline{ψ} = \overline{y} + {γ}^{2} ( {\overline{ψ}}_{2 , 0} - \frac{\overline{y}}{{\overline{r}}^{2}} ) + … , \qquad ( A .5 )$$

To force ψ̅ to satisfy the equations (23), including the boundary conditions at y̅=±1, one must impose the following conditions on ψ̅_{2,0}

$${∇}^{2} {\overline{ψ}}_{2 , 0} = 0 \\ {\overline{ψ}}_{2 , 0} = - {\overline{Z}}_{W} [ \frac{\partial {\overline{ψ}}_{2 , 0}}{\partial \overline{y}} - \frac{{\overline{x}}^{2} - {\overline{y}}^{2}}{{\overline{r}}^{4}} ] + \frac{\overline{y}}{{\overline{r}}^{2}} at \overline{y} = 1 \\ {\overline{ψ}}_{2 , 0} = - {\overline{Z}}_{W} [ \frac{\partial {ψ}_{2 , 0}}{\partial \overline{y}} - \frac{{\overline{x}}^{2} - 1}{{( {\overline{x}}^{2} + 1 )}^{2}} ] + \frac{1}{( {\overline{x}}^{2} + 1 )} at \overline{y} = 1 {\overline{ψ}}_{2 , 0} = {\overline{Z}}_{C} [ \frac{\partial {\overline{ψ}}_{2 , 0}}{\partial \overline{y}} - \frac{\partial }{\partial \overline{y}} ( \frac{\overline{y}}{{\overline{r}}^{2}} ) ] + \frac{\overline{y}}{{\overline{r}}^{2}} \\ = {\overline{Z}}_{C} [ \frac{\partial {\overline{ψ}}_{2 , 0}}{\partial \overline{y}} + \frac{{\overline{x}}^{2} - 1}{{( {\overline{x}}^{2} + 1 )}^{2}} ] - \frac{1}{( {\overline{x}}^{2} + 1 )} at \overline{y} = - 1 {\overline{ψ}}_{2 , 0} \to 0 as \overline{x} \to \pm ∞ \qquad ( A .6 )$$

Note that the function ψ̅_{2,0} is defined on the entire region −∞<x̅<∞, −1≦y̅≦1 because no boundary conditions are imposed on the wire surface. One now proceeds to write equation (A.5) in the inner coordinates, but first some background is given on how best to express ψ̅_{2,0} in the inner coordinate system.

Because of the rotational symmetry of the inner problem, it is easier to express solutions to the inner problem in polar coordinates r̅,θ or r̅,θ where sin θ=ŷ/\hat{r}=y̅/r̅. Any solution to the equation ∇²1̅0̅4̅ _{2,0}=0 can be written in some neighborhood of r̅=0 as a series in which each term is a circular harmonic function obtained by separation of variables [19], of the form

$$\begin{matrix}{\overline{ψ}}_{2 , 0} = {B}_{0} + {B}_{1} \overline{r} sin θ + {B}_{2} {\overline{r}}^{2} cos 2 θ + {B}_{3} {\overline{r} }^{3} sin 3 θ + … \\ = {B}_{0} + γ {B}_{1} \hat{r} sin θ + {γ}^{2} {B}_{2} {\hat{r}}^{2} cos 2 θ + {γ}^{3} {B}_{3} {\hat{r}}^{3} sin 3 θ + …\end{matrix} \qquad ( A .7 )$$

The choice of sine or cosine functions in equation (A.7) stems from the symmetry of ψ̅_{2,0} under reversal of the x̅-axis. The coefficients are given as

$${B}_{0} = {\overline{ψ}}_{2 , 0} ( 0 , 0 ) , {B}_{1} = \frac{\partial {\overline{ψ}}_{2 , 0}}{\partial \overline{y}} {{\vert}_{\overline{r} = 0} , {B}_{2} = - \frac{1}{2} \frac{{\partial }^{2} {\overline{ψ}}_{2 , 0}}{\partial {\overline{y}}^{2}} \vert}_{\overline{r} = 0} , … \qquad ( A .8 )$$

Note that each successive term in equation (A.7), when written in the inner coordinates, becomes higher order in γ and thus smaller for values of γ≦1, particularly in the limit of small γ; successive terms in the outer solution also become smaller as long as r̅ is small. The form of equation (A.7) is well suited to the outer solution, because it has no singularities at r̅=0; however, it does not satisfy the boundary conditions at the reference wire. It can be modified for use as an inner solution by adding extra terms, so it becomes

$$\begin{matrix}{\hat{ψ}}_{2 , 0} = {B}_{0} + {B}_{1} ( \overline{r} - \frac{{γ}^{2}}{\overline{r}} ) sin θ + {B}_{2} ( {\overline{r}}^{2} - \frac{{γ}^{4}}{{\overline{r}}^{2}} ) cos 2 θ + {B}_{3} ( {\overline{r}}^{3} - \frac{{γ}^{6}}{{\overline{r}}^{3}} ) sin 3 θ + … \\ = {B}_{0} + γ {B}_{1} ( \hat{r} - \frac{1}{\hat{r}} ) sin θ + {γ}^{2} {B}_{2} ( {\hat{r}}^{2} - \frac{1}{{\hat{r}}^{2}} ) cos 2 θ + {γ}^{3} {B}_{3} ( {\hat{r}}^{3} - \frac{1}{{\hat{r}}^{3}} ) sin 3 θ + …\end{matrix} \qquad ( A .9 )$$

Equation (A.9) now satisfies the boundary conditions at the reference wire. Note that

\hat{ψ}_{2,0}(\hat{r}=1)=B₀ (A.10)

A version of the inner solution that can be matched to the outer solution in equation (A.5) on some overlap region is derived. The inner solution should also contain terms of order γ² and the difference between the inner and outer solution in the overlap region must be much smaller than γ² to show consistency in the matching, equation (A.7) for ψ̅_{2,0} is truncated, thus obtaining

$${\overline{ψ}}_{2 , 0} = {\overline{ψ}}_{2 , 0} ( 0 , 0 ) + γ \frac{\partial {\overline{ψ}}_{2 , 0}}{\partial \overline{y}} {\vert}_{\overline{r} = 0} \hat{y} + O ( {γ}^{2} ) \qquad ( A .11 )$$

where O(γ²) represents terms that are order γ² or higher. Inserting equation (A.11) into equation (A.5), one obtains

$$\begin{matrix}\overline{ψ} = \overline{y} + {γ}^{2} ( {\overline{ψ}}_{2 , 0} - \frac{sin θ}{\overline{r}} ) & ( A .12 ) \\ \hat{ψ} = γ ( \hat{y} - \frac{sin θ}{\hat{r}} ) + {γ}^{2} {\overline{ψ}}_{2 , 0} ( 0 , 0 ) + {γ}^{3} \frac{\partial {\overline{ψ}}_{2 , 0}}{\partial \overline{y}} {\vert}_{\overline{r} = 0} \hat{y} + O ( {γ}^{4} ) & \end{matrix}$$

The next step is to convert the series (A.7) for ψ̅_{2,0} into the series (A.9) for \hat{ψ}_{2,0} so that it is part of the inner solution. Using equation (A.12), the following are written:

$$\hat{ψ} = γ ( \hat{y} - \frac{sin θ}{\hat{r}} ) + {γ}^{2} {\overline{ψ}}_{2 , 0} ( 0 , 0 ) + {γ}^{3} \frac{\partial {\overline{ψ}}_{2 , 0}}{\partial \overline{y}} {\vert}_{\overline{r} = 0} ( \hat{y} - \frac{sin θ}{\hat{r}} ) \\ \begin{matrix}\overline{ψ} - \hat{ψ} = {γ}^{2} [ {\overline{ψ}}_{2 , 0} - {\overline{ψ}}_{2 , 0} ( 0 , 0 ) - γ \frac{\partial {\overline{ψ}}_{2 , 0}}{\partial \overline{y}} {\vert}_{\overline{r} = 0} \hat{y} ] + {γ}^{3} \frac{\partial {\overline{ψ}}_{2 , 0}}{\partial \overline{y}} {\vert}_{\overline{r} = 0} \frac{sin θ}{\hat{r}} \\ = {γ}^{2} [ {\overline{ψ}}_{2 , 0} - {\overline{ψ}}_{2 , 0} ( 0 , 0 ) - \frac{\partial {\overline{ψ}}_{2 , 0}}{\partial \overline{y}} {\vert}_{\overline{r} = 0} \overline{y} ] + {γ}^{4} \frac{\partial {\overline{ψ}}_{2 , 0}}{\partial \overline{y}} {\vert}_{\overline{r} = 0} \frac{sin θ}{\overline{r}}\end{matrix} \qquad ( A .13 )$$

The difference between the inner and outer solutions must be much smaller than γ², which will be the case as long as r̅<<1 so that the term in brackets is much smaller than one. It follows that the matching region is given as γ≦r̅<<1.

To increase the accuracy of the inner and outer solutions one additional term is added to the series solutions for ψ̅_{2,0}. This results in

$$\begin{matrix}{\overline{ψ}}_{2 , 0} = {\overline{ψ}}_{2 , 0} ( 0 , 0 ) + γ \frac{\partial {\overline{ψ}}_{2 , 0}}{\partial \overline{y}} {\vert}_{\overline{r} = 0} \hat{y} - \frac{{γ}^{2}}{2} \frac{{\partial }^{2} {\overline{ψ}}_{2 , 0}}{\partial {\overline{y}}^{2}} {\vert}_{\overline{r} = 0} {\hat{r}}^{2} cos 2 θ + O ( {γ}^{3} ) & ( A .14 ) \\ {\hat{ψ}}_{2 , 0} = {\overline{ψ}}_{2 , 0} ( 0 , 0 ) + γ \frac{\partial {\overline{ψ}}_{2 , 0}}{\partial \overline{y}} {\vert}_{\overline{r} = 0} ( \hat{y} - \frac{sin θ}{\hat{r}} ) - \frac{{γ}^{2}}{2} \frac{{\partial }^{2} {\overline{ψ}}_{2 , 0}}{\partial {\overline{y}}^{2}} {\vert}_{\overline{r} = 0} ( {\hat{r}}^{2} - \frac{1}{{\hat{r}}^{2}} ) cos 2 θ + O ( {γ}^{3} ) & \\ \hat{ψ} = γ ( \hat{y} - \frac{sin θ}{\hat{r}} ) + {γ}^{2} {\overline{ψ}}_{2 , 0} ( 0 , 0 ) + {γ}^{3} \frac{\partial {\overline{ψ}}_{2 , 0}}{\partial \overline{y}} {\vert}_{\overline{r} = 0} ( \hat{y} - \frac{sin θ}{\hat{r}} ) - \frac{{γ}^{4}}{2} \frac{{\partial }^{2} {\overline{ψ}}_{2 , 0}}{\partial {\overline{y}}^{2}} {\vert}_{\overline{r} = 0} ( {\hat{r}}^{2} - \frac{1}{{\hat{r}}^{2}} ) cos 2 θ + O ( {γ}^{5} ) & \end{matrix}$$

When the last of equations (A.14) is written in the outer coordinates, it becomes

$$\overline{ψ} = \overline{y} + {γ}^{2} ( {\overline{ψ}}_{2 , 0} - \frac{sin θ}{\overline{r}} ) - {γ}^{4} \frac{\partial {\overline{ψ}}_{2 , 0}}{\partial \overline{y}} {\vert}_{ \overline{r} = 0} \frac{sin θ}{\overline{r}} + \frac{{γ}^{6}}{2} \frac{{\partial }^{2} {\overline{ψ}}_{2 , 0}}{\partial {\overline{y}}^{2}} {\vert}_{\overline{r} = 0} \frac{cos 2 θ}{{\overline{r}}^{2}} \qquad ( A .15 )$$

Since carrying terms up to γ⁴ is of the greatest interest, the term of order γ⁶ in equation (A.15) can be dropped, but the term of order γ⁴ no longer satisfies the boundary conditions at y̅=±1. To correct this, one simply adds another copy of ψ̅_{2,0} which results in

$$\overline{ψ} = \overline{y} + {γ}^{2} ( {\overline{ψ}}_{2 , 0} - \frac{sin θ}{\overline{r}} ) ( 1 + {γ}^{2} \frac{\partial {\overline{ψ}}_{2 , 0}}{\partial \overline{y}} {\vert}_{\overline{r} = 0} ) \qquad ( A .16 )$$

This is the outer solution to an accuracy of γ⁴. The inner solution is again obtained by converting equation (A.16) into the inner coordinates and adding some terms to satisfy the boundary conditions at \hat{r}=1. The result, after dropping terms higher order than γ⁴, is (compare with equation (A.14))

$$\begin{matrix}\hat{ψ} = [ γ ( \hat{y} - \frac{sin θ}{\hat{r}} ) + {γ}^{2} {\overline{ψ}}_{2 , 0} ( 0 , 0 ) ] ( 1 + {γ}^{2} \frac{\partial {\overline{ψ}}_{2 , 0}}{\partial \overline{y}} {\vert}_{\overline{r} = 0} ) + {{γ}^{5} [ \frac{\partial {\overline{ψ}}_{2 , 0}}{\partial \overline{y}} {\vert}_{\overline{r} = 0} ]}^{2} ( \hat{y} - \frac{sin θ}{\hat{r}} ) - \frac{{γ}^{4}}{2} \frac{{\partial }^{2} {\overline{ψ}}_{2 , 0}}{\partial {\overline{y}}^{2}} {\vert}_{\overline{r} = 0} cos 2 θ ( {\hat{r}}^{2} - \frac{1}{{\hat{r}}^{2}} ) & ( A .17 ) \\ \hat{ψ} = [ γ ( \hat{y} - \frac{sin θ}{\hat{r}} ) + {γ}^{2} {\overline{ψ}}_{2 , 0} ( 0 , 0 ) ] ( 1 + {γ}^{2} \frac{\partial {\overline{ψ}}_{2 , 0}}{\partial \overline{y}} {\vert}_{\overline{r} = 0} ) - \frac{{γ}^{4}}{2} \frac{{\partial }^{2} {\overline{ψ}}_{2 , 0}}{\partial {\overline{y}}^{2}} {\vert}_{\overline{r} = 0} cos 2 θ ( {\hat{r}}^{2} - \frac{1}{{\hat{r}}^{2}} ) & \\ \begin{matrix}\overline{ψ} - \hat{ψ} = {γ}^{2} [ {\overline{ψ}}_{2 , 0} - {\overline{ψ}}_{2 , 0} ( 0 , 0 ) + γ \frac{\partial {\overline{ψ}}_{2 , 0}}{\partial \overline{y}} {\vert}_{\overline{r} = 0} \hat{y} - \frac{{γ}^{2}}{2} \frac{{\partial }^{2} {\overline{ψ}}_{2 , 0}}{\partial {\overline{y}}^{2}} {\vert}_{\overline{r} = 0} {\hat{r}}^{2} cos 2 θ ] - \frac{{γ}^{4}}{2} \frac{{\partial }^{2} {\overline{ψ}}_{2 , 0}}{\partial {\overline{y}}^{2}} {\vert}_{\overline{r} = 0} \frac{cos 2 θ}{{\hat{r}}^{2}} \\ = {γ}^{2} [ {\overline{ψ}}_{2 , 0} - {\overline{ψ}}_{2 , 0} ( 0 , 0 ) + \frac{\partial {\overline{ψ}}_{2 , 0}}{\partial \overline{y}} {\vert}_{\overline{r} = 0} \overline{y} - \frac{1}{2} \frac{{\partial }^{2} {\overline{ψ}}_{2 , 0}}{\partial {\overline{y}}^{2}} {\vert}_{\overline{r} = 0} {\overline{r}}^{2} cos 2 θ ] -- \frac{{γ}^{6}}{2} \frac{{\partial }^{2} {\overline{ψ}}_{2 , 0}}{\partial {\overline{y}}^{2}} {\vert}_{\overline{r} = 0} \frac{cos 2 θ}{{\overline{r}}^{2}}\end{matrix} & \end{matrix}$$

The difference between the inner and the outer solution must be much smaller than γ⁴ in the matching region. As before, this places a constraint on the size of the term in brackets, which must be much less than γ² when considered in the outer coordinates. Since the series for ψ̅_{2,0} was truncated after the quadratic term, the bracketed term is order r̅³ and its product with γ² must satisfy γ²r̅³<<γ⁴, which requires that r̅ <<γ^{2/3}. The term of order γ⁴ in the difference, using the inner coordinates, must also have a size much smaller than one and requires \hat{r}<<1, r̅<<γ. The matching overlap region thus becomes γ<<r̅<<γ^{2/3}, 1<<\hat{r}<<γ^{-1/3}.

Equation (A.17) results in the following form for the potential at the reference wire

$$\overline{ψ} ( γ ) = {γ}^{2} {\overline{ψ}}_{2 , 0} ( 0 , 0 ) ( 1 + {γ}^{2} \frac{\partial {\overline{ψ}}_{2 , 0}}{\partial \overline{y}} {\vert}_{\overline{r} = 0} ) \qquad ( A . 18 )$$

The procedure for increasing the order in γ of the inner and outer solutions can be repeated, but this time a new problem occurs. The appearance of terms of the form

$$cos 2 θ ( {\hat{r}}^{2} - \frac{1}{{\hat{r}}^{2}} )$$

leads to new terms in the outer solution which do not solve the boundary conditions at the electrodes. Thus one must introduce a new function ψ̅_{4,0}, in analogy to ψ̅_{2,0}, to correct this problem. This would result in additional numerical calculations needed to solve for both ψ̅_{2,0} and 1̅0̅4̅ _{4,0}, and this is avoided by terminating the matching at an order of γ⁴. However, one can derive a useful alternative to equations (A.16) and (A.18) by simply assuming that all derivatives of ψ̅_{2,0} higher than first order vanish. By making this assumption, the need to introduce further functions such as ψ̅_{4,0} is removed and one can proceed to iterate the matching process using only the function ψ̅_{2,0}.

At this point, an iterative process starts to take shape. Under the assumption of vanishing higher derivatives, one can assume that

$${\overline{ψ}}_{2 , 0} = {\overline{ψ}}_{2 , 0} ( 0 , 0 ) + γ \frac{\partial {\overline{ψ}}_{2 , 0}}{\partial \overline{y}} {\vert}_{\overline{r} = 0} \hat{y} \qquad ( A . 19 )$$

in the matching process. When equation (A.19) is used with equation (A.16) in the matching process, the only term that does not satisfy the boundary conditions at the reference wire is of the form

$${{γ}^{5} [ \frac{\partial {\overline{ψ}}_{2 , 0}}{\partial \overline{y}} {\vert}_{\overline{r} = 0} ]}^{2} \hat{y} ,$$

which must then be altered to

$${{γ}^{5} [ \frac{\partial {\overline{ψ}}_{2 , 0}}{\partial \overline{y}} {\vert}_{\overline{r} = 0} ]}^{2} ( \hat{y} - \frac{\hat{y}}{{\hat{r}}^{2}} ) .$$

After converting back to the outer coordinates, and correcting it to satisfy the boundary conditions at the electrodes, it results in an additional factor

$${{γ}^{6} [ \frac{\partial {\overline{ψ}}_{2 , 0}}{\partial \overline{y}} {\vert}_{\overline{r} = 0} ]}^{2} ( {\overline{ψ}}_{2 , 0} - \frac{\overline{y}}{{\overline{r}}^{2}} ) .$$

The outer solution then takes the form

$$\overline{ψ} = \overline{y} + {γ}^{2} [ 1 + {γ}^{2} \frac{\partial {\overline{ψ}}_{2 , 0}}{\partial \overline{y}} {\vert}_{\overline{r} = 0} + {( {γ}^{2} \frac{\partial {\overline{ψ}}_{2 , 0}}{\partial \overline{y}} {\vert}_{\overline{r} = 0} )}^{2} ] ( {\overline{ψ}}_{2 , 0} - \frac{\overline{y}}{{\overline{r}}^{2}} ) \qquad ( A . 20 )$$

The procedure is repeated ad infinitum and results in

$$\begin{matrix}\overline{ψ} = \overline{y} + {γ}^{2} [ 1 + {γ}^{2} \frac{\partial {\overline{ψ}}_{2 , 0}}{\partial \overline{y}} {\vert}_{\overline{r} = 0} + {( {γ}^{2} \frac{\partial {\overline{ψ}}_{2 , 0}}{\partial \overline{y}} {\vert}_{\overline{r} = 0} )}^{2} + \\ {( {γ}^{2} \frac{\partial {\overline{ψ}}_{2 , 0}}{\partial \overline{y}} {\vert}_{\overline{r} = 0} )}^{3} + … ] \times ( {\overline{ψ}}_{2 , 0} - \frac{\overline{y}}{{\overline{r}}^{2}} ) \\ = \overline{y} + {γ}^{2} \frac{( {\overline{ψ}}_{2 , 0} - \frac{\overline{y}}{{\overline{r}}^{2}} )}{1 - {γ}^{2} \frac{\partial {\overline{ψ}}_{2 , 0}}{\partial \overline{y}} {\vert}_{\overline{r} = 0}}\end{matrix} \qquad ( A . 21 )$$

The corresponding formula can be written in the inner coordinates as

$$\begin{matrix}\overline{ψ} = γ \hat{y} + {γ}^{2} [ 1 + {γ}^{2} \frac{\partial {\overline{ψ}}_{2 , 0}}{\partial \overline{y}} {\vert}_{\overline{r} = 0} + {( {γ}^{2} \frac{\partial {\overline{ψ}}_{2 , 0}}{\partial \overline{y}} {\vert}_{\overline{r} = 0} )}^{2} + \\ {( {γ}^{2} \frac{\partial {\overline{ψ}}_{2 , 0}}{\partial \overline{y}} {\vert}_{\overline{r} = 0} )}^{3} + … ] \times \\ ( {\overline{ψ}}_{2 , 0} ( 0 , 0 ) + γ - \frac{\partial {\overline{ψ}}_{2 , 0}}{\partial \overline{y}} {\vert}_{\overline{r} = 0} \hat{y} - \frac{\hat{y}}{γ {\hat{r}}^{2}} ) \\ = \frac{γ ( \hat{y} - \frac{\hat{y}}{{\hat{r}}^{2}} ) + {γ}^{2} {\overline{ψ}}_{2 , 0} ( 0 , 0 )}{1 - {γ}^{2} \frac{\partial {\overline{ψ}}_{2 , 0}}{\partial \overline{y}} {\vert}_{\overline{r} = 0}}\end{matrix} \qquad ( A . 22 )$$

In going from the first to the second of equations (A.22), some re-ordering of the terms in the infinite series is necessary. Since equations (A.21) and (A.22) are based on ignoring the second and higher order derivatives of ψ̅_{2,0}, they are also missing terms that are order γ⁶ and higher; in this sense, they are no more accurate than equations (A.16) and (A.17). However, numerical simulations of the function ψ̅_{2,0} in specific cases indicate that its second derivative is much smaller than its first derivative and this increases the accuracy of equations (A.21) and (A.22). Direct comparison with numerical simulations of ψ̅ for specific γ-values, based on the full set of equations (23) and (24), also confirms in these cases a higher level of accuracy. (See, in particular, FIG. 5(a).) In any event, the function ψ̅_{2,0} must always be numerically determined and its second derivative can be estimated. For this reason, use of equations (A.21) and (A.22) is suggested.

The potential value at the reference wire thus becomes

$$\overline{ψ} ( γ ) = {γ}^{2} \frac{{\overline{ψ}}_{2 , 0} ( 0 , 0 )}{1 - {γ}^{2} \frac{\partial {\overline{ψ}}_{2 , 0}}{\partial \overline{y}} {\vert}_{\overline{r} = 0}} \qquad ( A . 23 )$$

Equation (A.23) can be generalized to the case when a surface resistance exists on the reference wire, in which case the boundary conditions on the wire are given as

$$K \frac{\partial \overline{ψ}}{\partial \overline{r}} {\vert}_{\overline{r} = γ} = \overline{ψ} {\vert}_{\overline{r} = γ} - {\overline{Ψ}}_{0} \\ {\int }_{0}^{2 π} \frac{\partial \overline{ψ}}{\partial \overline{r}} {\vert}_{\overline{r} = γ} d θ = 0 \qquad ( A . 24 )$$

(See the second of equations (24) and equation (32).) In the inner coordinates, the first of equations (A.24) becomes

$$K \frac{\partial \hat{ψ}}{\partial \hat{r}} {\vert}_{\hat{r} = 1} = γ ( \hat{ψ} {\vert}_{\hat{r} = 1} - {\hat{Ψ}}_{0} ) \qquad ( A . 25 )$$

In order to solve this boundary condition, the leading order inner solution becomes

$$\hat{ψ} = γ ( \hat{r} - \frac{Γ}{\hat{r}} ) sin θ = \overline{y} - {γ}^{2} Γ \frac{\overline{y}}{{\overline{r}}^{2}} where Γ = \frac{γ - K}{γ + K} \qquad ( A . 26 )$$

(Compare with equation (A.4).) Furthermore, one must modify equation (A.9) to take the form

$${\hat{ψ}}_{2 , 0} = {B}_{0} + {γB}_{1} ( \hat{r} - \frac{Γ}{\hat{r}} ) sin θ + {γ}^{2} {B}_{2} ( {\hat{r}}^{2} - \frac{Γ}{{\hat{r}}^{2}} ) cos 2 θ + {γ}^{3} {B}_{3} ( {\hat{r}}^{3} - \frac{Γ}{{\hat{r}}^{3}} ) sin 3 θ + … \qquad ( A . 27 )$$

The rest of the analysis goes through in much the same way as before and results in the following generalization to equation (A.23)

$${\overline{Ψ}}_{0} = {γ}^{2} Γ \frac{{\overline{ψ}}_{2 , 0} ( 0 , 0 )}{1 - {γ}^{2} Γ \frac{\partial {\overline{ψ}}_{2 , 0}}{\partial \overline{y}} {\vert}_{\overline{r} = 0}} \qquad ( A . 28 )$$

TABLE 1

| Variable | Value | Dimensionless form | Value |
|---|---|---|---|
| R₁ | 0.1 Ohm-cm² | R̅₁ | 0.8666 |
| C₁ | 10 F/cm² | | |
| R₂ | 0.1 Ohm-cm² | R̅₂ | 0.8666 |
| C₂ | 0.01 F/cm² | | |
| $R = \frac{L}{σ}$ | 0.23 Ohm-cm² | R̅ | 2 |
| L | 150 μm | | |
| σ | 0.065 (Ohm-cm)^{- -1} | | |
| | | Y = 1 − γ²Γ | |
| Z_{W} | $\frac{{R}_{1}}{1 + 2 π {jR}_{1} {C}_{1} ω}$ | ${\overline{Z}}_{W} = \frac{{\overline{R}}_{1}}{1 + 2 π {jR}_{1} {C}_{1} ω}$ | |
| Z_{C} | $\frac{{R}_{2}}{1 + 2 π {jR}_{2} {C}_{2} ω}$ | ${\overline{Z}}_{C} = \frac{{\overline{R}}_{2}}{1 + 2 π {jR}_{2} {C}_{2} ω}$ | |
| X | 0.5* | | |
| a₁ | 100 cm²* | | |
| a₂ | 1 cm²* | | |

Values for the parameters taken from FIG. 6 of [9]. The geometry of the cell is represented schematically in FIG. 2(a).
Parameters with an asterisk (*) are estimated for use in equation (6), which was used to create the Nyquist plots shown in Figures 2(b) and (c).
In [9], it is stated that the area of the cell was approximately 100 times the cross-sectional area of the separator at the edge; this motivates the assumption that a₂ << a₁ in equation (5), which then simplifies to equation (6), in order to approximate values for the reference impedance.
Dimensionless forms of the variables are taken from equation (22).

TABLE 2

| | | Comments |
|---|---|---|
| Z̅^{ref} = 1 + Z̅_{W} − Ψ̅₀ | | Ψ̅₀ is the |
| | | dimensionless potential |
| | | of the reference wire. |
| | | -Ψ̅₀ is also the |
| | | dimensionless form of |
| | | the impedance artifacts. |
| $\begin{matrix}{\overline{Ψ}}_{0} = {γ}^{2} Γ \frac{{\overline{ψ}}_{2 , 0} ( 0 , 0 )}{1 - {γ}^{2} Γ \frac{\partial {\overline{ψ}}_{2 , 0}}{\partial \overline{y}} {\vert}_{\overline{r} = 0}} \\ {\overline{Ψ}}_{0} = {γ}^{2} Γ {\overline{ψ}}_{2 , 0} ( 0 , 0 ) ( 1 + {γ}^{2} Γ \frac{\partial {\overline{ψ}}_{2 , 0}}{\partial \overline{y}} {\vert}_{\overline{r} = 0} )\end{matrix}$ | $Γ = \frac{γ - K}{γ + K}$ | Asymptotic formulas. The function ψ̅_{2,0} (x̅, y̅) must be determined numerically. Both formulas have O( γ⁶Γ³) errors, but the upper formula appears to be |
| | | more accurate when |
| | | compared to numerical |
| | | simulations. |
| ${\overline{Ψ}}_{0} = ( 1 - Y ) \frac{{\overline{Z}}_{C} - {\overline{Z}}_{W}}{( {\overline{Z}}_{W} + {\overline{Z}}_{C} + 2 Y )}$ | Y = 1 − γ²Γ | Based on the equivalent circuit in FIG. 1, where X = ½. |
| ${Z}_{W} = \frac{L}{2 σ} {\overline{Z}}_{W} , {Z}_{C} = \frac{L}{2 σ} {\overline{Z}}_{C} , γ = \frac{2 {R}_{0}}{L} , {Ψ}_{0} = {\tilde{V}}_{sep} {\overline{Ψ}}_{0}$ ${Z}^{ref} = \frac{L}{2 σ} {\overline{Z}}^{ref} , K = \frac{2 {ρ}_{s} σ}{L} , R = \frac{L}{σ} , r = \frac{L \overline{r}}{2}$ | | Dimensionless variables appear with an overbar. See table of Nomenclature. |

Summary of the formulas for impedance and impedance artifacts. If no artifacts are present, then Z̅^{ref} =
1 + Z̅_{W}.

TABLE 3
Nomenclature

| | |
|---|---|
| a₁, a₂ | Areas of regions 1 and 2 in the schematic diagram of FIG. 1, cm² |
| i | Current density, A/cm² |
| Ī | Average dimensionless current, A/cm² |
| I₁, I₂ | Current in regions 1 and 2 of the schematic diagram of FIG. 1, A |
| K | Dimensionless interfacial surface resistance on the reference wire. See |
| | Table 2 |
| L | Separator thickness, cm |
| r | Radial coordinate in FIG. 3, r = \sqrt{x² + y²} |
| R | Separator resistance, Ohm-cm² |
| R₀ | Radius of reference wire, cm |
| x | Coordinate in FIG. 3, cm |
| X | Parameter in circuit diagram. See FIG. 1 |
| y | Coordinate in FIG. 3, cm |
| Y | Parameter in circuit diagram. See FIG. 1 |
| V | Voltage between current collectors of the cell, V |
| V^{ref} | Voltage between current collector of the working electrode and the |
| | reference electrode, V |
| Δ\tilde{V}_{W}, Δ\tilde{V}_{C} | Voltage difference between current collector and separator in working or |
| | counter electrode. See FIG. 3, V |
| \tilde{V}ₛₑₚ | Voltage difference across the separator at large distance from the |
| | reference wire. See FIG. 3, V |
| Z^{ref} | Impedance of the working electrode with respect to the reference |
| | electrode, |
| | Ohm-cm² |
| Z_{W} | Impedance of working electrode. See FIG. 1, Ohm-cm² |
| Z_{C} | Impedance of counter electrode. See FIG. 1, Ohm-cm² |
| Z (W, C) | Impedance between working and counter electrodes, including separator, |
| | Ohm-cm² |
| γ | Ratio of reference-wire diameter to separator thickness |
| Γ | Dimensionless parameter, see Table 2. |
| ψ | Potential function, V |
| ψ̅_{2, 0} | Dimensionless potential solving equations (A.6) |
| Ψ₀ | Potential of reference wire, V |
| ρₛ | Surface resistance on wire, see equation (31), Ohm-cm² |
| σ | Conductivity in separator, Ohm⁻¹cm⁻¹ |
| ω | Frequency, Hz |
| Overbar | Dimensionless form, outer solution in the Appendix |
| Hat \hat{ } | Referring to inner solution in the Appendix |
| Tilde \tilde{ } | Fourier Transform |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### REFERENCES

1. A. J. Bard and L. R. Faulkner, Electroanalytical Methods. Fundamentals and Applications, 2^{nd} edition, Wiley, New York, N.Y. (2002).

2. J. Newman and K. E. Thomas-Aleya, Electrochemical Systems, 3^{rd} edition, Wiley, New York, N.Y., 2004.

3. J. Newman and W. Tiedemann, J. Electrochem. Soc., 140(1993)1961-1968.

4. A. C. West and J. Newman, J. Electrochem. Soc., 136(1989)3755-3759.

5. J. Winkler, P. V. Hendriksen, N. Bonanos, and M. Mogensen, J. Electrochem. Soc., Vol. 145, No. 4, (1998)1184-1192.

6. Y. A. Gandomi, D. S. Aaron, T. A. Zawodzinski and M. M. Mench, J. Electrochem. Soc., 163 (1) A5188-A5201 (2016).

7. S. Wu and J. Liu, S. Wu and J. Liu, “Development of a Long-Life Lithium Reference Electrode for Automotive Lithium Ion Battery Cells—Part I,” CSL—003, Dec. 29, 2011.

8. Z. Yu, K. Chen, S. Deng, and S Wu, “Study of Low Temperature Performance of Lithium Manganese Oxide/Lithium Titantate Oxide (LMO/LTO) Lithium Ion Batteries for Start/Stop Applications,” CSL—021, Aug. 30, 2014.

9. S. B. Adler, J. Electrochem. Soc., 149 (5) E166-E172 (2002).

10. D. W. Dees, A. N. Jansen and Daniel P. Abraham, Journal of Power Sources 174 (2007) 1001-1006.

11. P. Liu, J. S. Wang, J. Hicks-Garner, E. Sherman, S. Soukiazian, M. Verbrugge, H. Tataria, J. Musser, and P. Finamore, J. Electrochem. Soc., 157(2010)A499.

12. M. Ender, A. Weber and E. Ivers-Tiffée, J. Electrochem. Soc., 159 (2) A128-A136 (2012).

13. M. D. Levi, V. Dargel, Y. Shilina, D. Aurbach, and I. Halalay, Electrochim. Acta, 149 (2014)126-135.

14. R. Zeng, R. C. T. Slade, and J. R. Varcoe, Electrochim. Acta, (2010) 607-619.

15. Y. Hoshi, Y. Narita, K. Honda, T. Ohtaki, I. Shitanda, and M. Itagaki, J. Power Sources, 288(2015)168-175.

16. J. Illig, J. P. Schmidt, M. Weiss, A. Weber, and E. Ivers-Tiffée, J. Power Sources, 239(2013)670-679.

17. E. McTurk, C. R. Birkl, M. R. Roberts, D. A. Howey, and P. G. Bruce, ECS Electrochemistry Letters, 4(2015)A145-A147.

18. D. R. Baker and M. W. Verbrugge, J. Electrochem. Soc., 160 (8) A1319-A1332 (2013).

19. P. Moon and D. E. Spencer, Field Theory Handbook, 2^{nd} Edition, Springer Verlag, Berlin, 1971.

20. M. E. Orazem and B. Tribollet, Electrochemical Impedance Spectroscopy, John Wiley and Sons, Inc., Hoboken, N.J., 2008.

21. http://www.comsol.com/

What is claimed is:

1. A thin-film cell comprising
a working electrode;
a counter electrode;
a separator disposed between the electrodes and holding the electrodes in a spaced apart relation;
an electrolyte in the separator and in fluid contact with the working electrode and the counter electrode;
a reference electrode disposed in the separator between the counter and working electrodes; and
wherein the reference electrode is a conductive wire having a resistive coating applied to its surface.

2. The thin-film cell of claim 1, wherein the resistive coating is an ion resistive coating.

3. The thin-film cell according to claim 1, wherein the resistive coating comprises an organic polymer.

4. The thin-film cell according to claim 1, wherein the resistive coating comprises a ceramic.

5. The thin-film cell according to claim 1, wherein the resistive coating comprises a nitride, carbide, oxide or sulfide of aluminum, calcium, magnesium, titanium, silicon, or zirconium.

6. The thin-film cell according to claim 1, wherein the reference electrode has a surface resistivity of 1×10⁻¹⁰ ohm-cm² or greater.

7. The thin-film cell of claim 1, wherein the electrolyte has a conductivity σ, the electrodes are spaced apart by a distance L, the radius of the reference electrode is R₀, and the surface resistivity of the reference electrode in ohm-cm² is numerically equal to the radius R₀ in cm divided by the conductivity σ in (ohm-cm)⁻¹.

8. A battery comprising a plurality of electrochemical cells, wherein at least one of the cells is a thin-film cell according to claim 1.

9. A lithium ion battery according to claim 8.

10. A method of constructing an electrochemical cell containing a working electrode and a counter electrode separated by a separator containing an electrolyte, and further comprising a reference electrode in the form of a wire disposed between the working and the counter electrode, the cell essentially free of impedance artifacts attributable to the presence of the reference electrode, the method comprising applying a resistive coating having a first thickness to the surface of the reference electrode, installing the electrode in the cell in the space between the working and the counter electrodes.

11. The method according to claim 10, comprising applying the resistive coating to a second thickness greater than the first thickness.

12. The method according to claim 10, further comprising testing the cell for impedance artifacts.

13. The method according to claim 10, comprising adding the resistive coating by a process selected from the group consisting of: atomic layer deposition, chemical vapor deposition, physical vapor deposition, radio frequency sputtering, and combinations thereof.

14. The method according to claim 10, comprising adding the resistive coating by dipping the wire in a molten organic polymer.

15. A thin-film electrochemical cell comprising
a working electrode;
a counter electrode;
a separator disposed between the electrodes and holding the electrodes in a spaced apart relation;
an electrolyte in the separator and in fluid contact with the working electrode and the counter electrode; and
a reference electrode disposed in the separator between the counter and working electrodes;
wherein the cell exhibits essentially no impedance artifacts attributable to the presence of the reference electrode.

16. The thin-film cell of claim 15, wherein the electrolyte has a conductivity σ, the electrodes are spaced apart by a distance L, the reference electrode is a wire having a radius of R₀, and the surface resistivity of the reference electrode in ohm-cm² is numerically equal to the radius R₀ in cm divided by the conductivity σ in (ohm-cm)⁻¹.

17. A rechargeable battery comprising a plurality of thin-film cells, wherein at least one to the thin-film cells in the battery is the thin-film cell according to claim 15.

18. A cell for electroorganic synthesis, comprising a thin-film cell according to claim 15.

19. A fuel cell comprising an electrochemical thin-film cell according to claim 15.
